(19) United States
(12) Patent Application Publication
(10) Pub. No.: US 2017/0061109 A1
(43) Pub. Date: Mar. 2, 2017

(54) ELECTRONIC APPARATUS, RECORDING MEDIUM, AND OPERATING METHOD OF ELECTRONIC APPARATUS

(71) Applicant: KYOCERA CORPORTION, Kyoto (JP)

(72) Inventor: Hayato TAKENOUCHI, Kizugawa-shi (JP)

(21) Appl. No.: 15/245,045

(22) Filed: Aug. 23, 2016

(30) Foreign Application Priority Data
Aug. 24, 2015 (JP) 2015-164548

(51) Int. Cl. G06F 21/32; G06K 9/00

(52) U.S. Cl. CPC G06F 21/32; G06K 9/00013; G06K 9/00087

(57) ABSTRACT

An electronic apparatus, a recording medium, and an operating method of an electronic apparatus are disclosed. In one embodiment, an electronic apparatus comprises a case, a first hardware button located in one of a right side surface and a left side surface of the case, a fingerprint sensor configured to detect a fingerprint of a finger being in contact with the first hardware button, an operation button, and at least one processor. The at least one processor is configured to execute user authentication based on a fingerprint detection result obtained by the fingerprint sensor and to execute a function assigned to the operation button in response to an operation performed on the operation button. The at least one processor executes the user authentication and the function when an operation is performed on the operation button in a state in which the first hardware button is in contact with a finger.

### CROSS-REFERENCE TO RELATED APPLICATION

The present application claims priority under 35 U.S.C. §119 to Japanese Patent Application No. 2015-164548, filed on Aug. 24, 2015, entitled “ELECTRONIC APPARATUS, CONTROL PROGRAM, AND OPERATING METHOD OF ELECTRONIC APPARATUS”. The content of which is incorporated by reference herein in its entirety.

### FIELD

Embodiments of the present disclosure relate generally to electronic apparatuses.

### BACKGROUND

Various techniques concerning electronic apparatuses have been proposed.

### SUMMARY

An electronic apparatus, a non-transitory computer readable recording medium, and an operating method of an electronic apparatus are disclosed. In one embodiment, an electronic apparatus comprises a case, a first hardware button, a fingerprint sensor, an operation button, and at least one processor. The first hardware button is located in one of a right side surface and a left side surface of the case. The fingerprint sensor is configured to detect a fingerprint of a finger being in contact with the first hardware button. The at least one processor is configured to execute user authentication based on a fingerprint detection result obtained by the fingerprint sensor and to execute a function assigned to the operation button in response to an operation performed on the operation button. The at least one processor executes the user authentication and the function when an operation is performed on the operation button in a state in which the first hardware button is in contact with a finger.

In one embodiment, a non-transitory computer readable recording medium is a recording medium that stores a control program for controlling an electronic apparatus. The apparatus comprises a case, a hardware button, a fingerprint sensor, and an operation button. The hardware button is located in one of a right side surface and a left side surface of the case. The fingerprint sensor is configured to detect a fingerprint of a finger being in contact with the hardware button. The control program causes the electronic apparatus to, when an operation is performed on the operation button in a state in which the hardware button is in contact with a finger, execute user authentication based on a fingerprint detection result obtained by the fingerprint sensor and execute the function assigned to the operation button.

In one embodiment, an operating method of an electronic apparatus is a method for use in an electronic apparatus comprising a case, a hardware button, a fingerprint sensor, and an operation button. The hardware button is located in one of a right side surface and a left side surface of the case. The fingerprint sensor is configured to detect a fingerprint of a finger being in contact with the hardware button. The method comprises executing user authentication based on a fingerprint detection result obtained by the fingerprint sensor and executing a function assigned to the operation button when an operation is performed on the operation button in a state in which the hardware button is in contact with a finger.

### BRIEF DESCRIPTION OF THE DRAWINGS

FIG. 1 is an illustration of a perspective view of an external appearance of an electronic apparatus.

FIG. 2 is an illustration of a front view of the external appearance of the electronic apparatus.

FIG. 3 is an illustration of a rear view of the external appearance of the electronic apparatus.

FIG. 4 is an illustration of a block diagram of the configuration of the electronic apparatus.

FIG. 5 is an illustration of exemplary display contents of the electronic apparatus.

FIG. 6 is an illustration of exemplary display contents of the electronic apparatus.

FIG. 7 is an illustration of a flowchart showing the operation of the electronic apparatus.

FIG. 8 is an illustration of exemplary display contents of the electronic apparatus.

FIG. 9 is an illustration of one example of the state in which a user operates the electronic apparatus.

FIG. 10 is an illustration of another example of the state in which the user operates the electronic apparatus.

FIG. 11 is an illustration of another example of the state in which the user operates the electronic apparatus.

FIG. 12 is an illustration of exemplary display contents of the electronic apparatus.

FIG. 13 is an illustration of another example of another example of the state in which the user operates the electronic apparatus.

FIG. 14 is an illustration of a flowchart showing the operation of the electronic apparatus.

FIG. 15 is an illustration of another example of the state in which the user operates the electronic apparatus.

FIG. 16 is an illustration of exemplary display contents of the electronic apparatus.

FIG. 17 is an illustration of another example of the state in which the user operates the electronic apparatus.

FIG. 18 is an illustration of exemplary display contents of the electronic apparatus.

FIG. 19 is an illustration of another example of the state in which the user operates the electronic apparatus.

FIG. 20 is an illustration of a flowchart showing the operation of the electronic apparatus.

FIG. 21 is an illustration of exemplary display contents of the electronic apparatus.

FIG. 22 is an illustration of exemplary display contents of the electronic apparatus.

FIG. 23 is an illustration of another example of the state in which the user operates the electronic apparatus.

FIG. 24 is an illustration of a block diagram of the configuration of the electronic apparatus.

FIG. 25 is an illustration of a flowchart showing the operation of the electronic apparatus.

FIG. 26 is an illustration of a flowchart showing the operation of the electronic apparatus.

FIG. 27 is an illustration of another example of the state in which the user operates the electronic apparatus.

FIG. 28 is an illustration of exemplary display contents of the electronic apparatus.

FIG. 29 is an illustration of another example of the state in which the user operates the electronic apparatus.

FIG. 30 is an illustration of another example of the state in which the user operates the electronic apparatus.

FIG. 31 is an illustration of a flowchart showing the operation of the electronic apparatus.

FIG. 32 is an illustration of a cross-sectional structure of part of the electronic apparatus.

### DETAILED DESCRIPTION

<External Appearance of Electronic Apparatus>

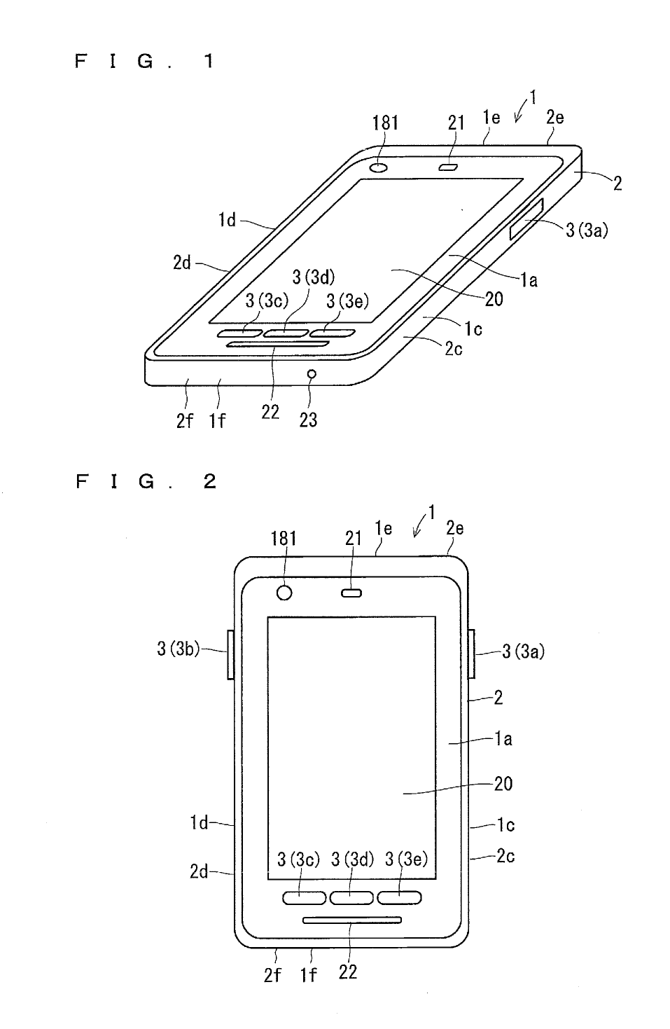

FIGS. 1 to 3 respectively illustrate a perspective view, a front view, and a rear view of an external appearance of an electronic apparatus 1. As illustrated in FIGS. 1 to 3, the electronic apparatus 1 includes an apparatus case 2 having an approximately rectangular plate shape in a plan view. The apparatus case 2 forms the exterior of the electronic apparatus 1. A front surface 1a of the electronic apparatus 1, namely, the front surface of the apparatus case 2 includes a display area 20 in which a variety of information, such as characters, signs, and graphics, is displayed. On a rear surface of the display area 20 is provided a touch panel 130, which will be described below. A user can input a variety of information to the electronic apparatus 1 by performing an operation on the display area 20 of the front surface 1a of the electronic apparatus 1 with, for example, a finger. Also, the user can input a variety of information to the electronic apparatus 1 by performing an operation on the display area 20 with an operator other than fingers, that is, for example, a pen for touch panels such as a stylus pen.

The electronic apparatus 1 has a right side surface 1c, a left side surface 1d, an upper side surface 1e, and a lower side surface 1f. The right side surface 2c, the left side surface 2d, the upper side surface 2e, and the lower side surface 2f of the apparatus case 2 respectively form the right side surface 1c, the left side surface 1d, the upper side surface 1e, and the lower side surface if of the electronic apparatus 1.

In the upper edge portion of the front surface 1a of the electronic apparatus 1 (the front surface of the apparatus case 2) is provided a receiver hole 21. In the lower edge portion of the front surface 1a of the electronic apparatus 1 is provided a speaker hole 22. In the lower side surface if of the electronic apparatus 1 is provided a microphone hole 23.

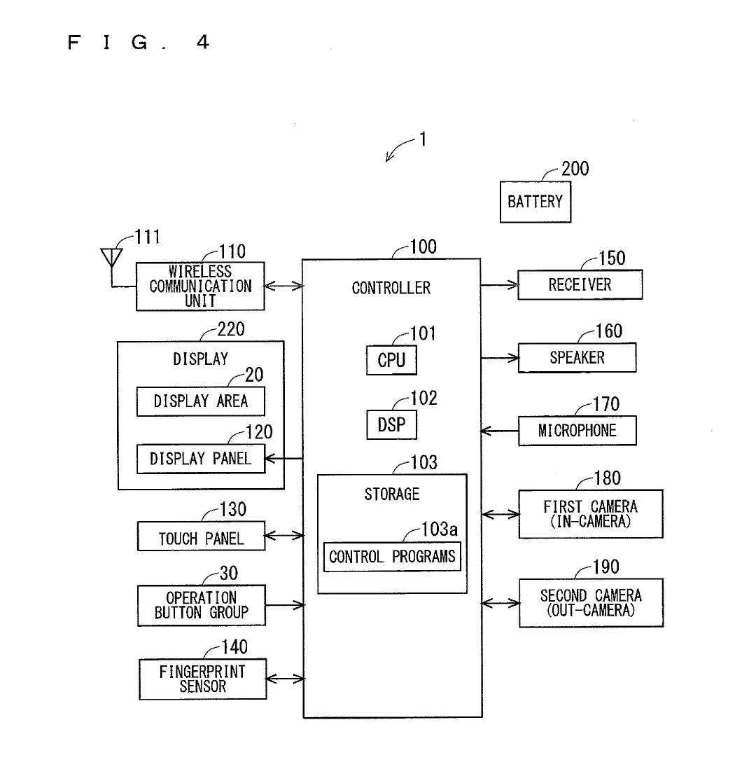

Through the upper edge portion of the front surface 1a of the electronic apparatus 1, an imaging lens 181 included in a first camera 180, which will be described below, can be visually recognized. As illustrated in FIG. 3, through the upper edge portion of a rear surface 1b of the electronic apparatus 1, an imaging lens 191 included in a second camera 190, which will be described below, can be visually recognized.

The electronic apparatus 1 includes a plurality of operation buttons 3. The individual operation buttons 3 are hardware buttons. Specifically, the individual operation buttons 3 are push buttons. The operation buttons are also referred to as “operation keys” or “keys”. The individual operation buttons 3 protrude from, for example, the surfaces of the apparatus case 2.

The individual operation buttons 3 have functions assigned thereto. At the press of the individual operation button 3, it is placed in the on state, and then, the electronic apparatus 1 can perform the function assigned to the operation button 3 placed in the on state. The plurality of operation buttons 3 include operation buttons 3a to 3e. The plurality of operation buttons 3 may be hereinafter collectively referred to as an “operation button group 30”. Performing an operation on the individual operation button 3 means pressing the operation button 3 to place it in the on state.

The operation button 3a is, for example, a power button. The power button is an operation button for suspending part of the functions or restoring (restarting) the suspended function of the electronic apparatus 1. The operation button 3a is located in the right side surface 1c of the electronic apparatus 1. The operation button 3a protrudes from, for example, the right side surface of the apparatus case 2 to the outside. In response to an operation performed by the user on the operation button 3a, the electronic apparatus 1 can suspend part of the functions or restore the suspended function. The operation button 3a is hereinafter also referred to as a power button 3a.

The operation button 3b is an operation button for executing, for example, an application (application program) assigned to the operation button 3b itself. The operation button 3b located in the left side surface 1d of the electronic apparatus 1. The operation button 3b protrudes from, for example, the left side surface of the apparatus case 2 to the outside. In response to an operation performed by the user on the operation button 3b, the electronic apparatus 1 can execute the application assigned to the operation button 3b. The user can perform an operation on the display area 20 to cause the electronic apparatus 1 to change the application to be assigned to the operation button 3b, The operation button 3b is hereinafter also referred to as an “application execution button 3b”.

The operation button 3c is, for example, a back button. The back button is an operation button for replacing the image in the display area 20 with the immediately preceding image. The operation button 3c is located in the lower edge portion of the front surface of the electronic apparatus 1. In response to an operation performed by the user on the operation button 3c, the image in the display area 20 is replaced with the immediately preceding image.

The operation button 3d is, for example, a home button. The home button is an operation button for causing a home screen to be displayed in the display area 20. The operation button 3d is located in the lower edge portion of the front surface of the electronic apparatus 1. In response to an operation performed by the user on the operation button 3d, the home screen is displayed in the display area 20.

The operation button 3e is, for example, a history button. The history button is an operation button for causing execution histories of applications in the electronic apparatus 1 to be displayed in the display area 20. The operation button 3e is located in the lower edge portion of the front surface of the electronic apparatus 1. In response to an operation performed by the user on the operation button 3e, execution histories of applications in the electronic apparatus 1 are displayed in the display area 20.

<Electrical Configuration of Electronic Apparatus>

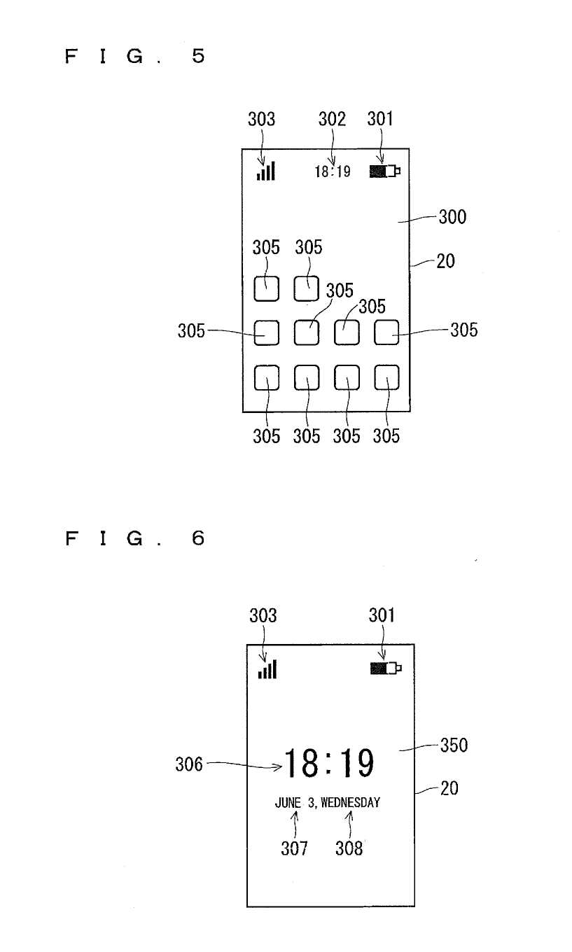

FIG. 4 is a block diagram mainly illustrating the electrical configuration of the electronic apparatus 1. As illustrated in FIG. 4, the electronic apparatus 1 includes a controller 100, a wireless communication unit 110, a display 220, the touch panel 130, the operation button group 30, and a fingerprint sensor 140. The electronic apparatus 1 further includes a receiver 150, a speaker 160, a microphone 170, the first camera 180, the second camera 190, and a battery 200. The constituent elements of the electronic apparatus 1 are accommodated in the apparatus case 2.

The controller 100 can manage the overall operation of the electronic apparatus 1 by controlling other constituent elements of the electronic apparatus 1. The controller 100 includes at least one processor for providing control and processing capability to perform various functions as will be described in further detail below. In accordance with various embodiments, the at least one processor may be implemented as a single integrated circuit (IC) or as multiple communicatively coupled ICs and/or discrete circuits. It is appreciated that the at least one processor can be implemented in accordance with various known technologies.

In one embodiment, the processor includes one or more circuits or units configurable to perform one or more data computing procedures or processes. For example, the processor may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein. Herein, the controller 100 is, for example, a control circuit comprising a CPU (central processing unit) 101, a DSP (digital signal processor) 102, a storage 103, and the like.

The storage 103 is formed of a non-transitory recording medium that can be read by the controller 100 (the CPU 101 and the DSP 102), such as a ROM (Read Only Memory) and a RAM (Random Access Memory). The storage 103 can store various control programs 103a for controlling the operation of the electronic apparatus 1, specifically, the operation of the individual constituent elements of the electronic apparatus 1 such as the wireless communication unit 110. The CPU 101 and the DSP 102 execute the various control programs 103a in the storage 103, so that the various functions of the controller 100 are performed. The storage 103 may include a non-transitory, computer-readable recording medium other than the ROM and the RAM. The storage 103 may include, for example, a compact hard disk drive and a SSD (solid state drive). Part or all of the functions of the controller 100 may be enabled by a hardware circuit that necessitates no software in performing the functions.

The control programs 103a in the storage 103 include various applications (application programs). The storage 103 stores, for example, a voice call application for performing voice calls and video calls, a browser for displaying webpages, an e-mail application for writing, reading, transmitting, and receiving e-mails, and a PTT (Push to Talk) application for performing push to talk communications. The storage 103 also stores, for example, a camera application for capturing images of subjects using the first camera 180 and the second camera 190, a map display application for displaying maps, a game application for playing games such as a puzzle game on the electronic apparatus 1, and a music playback control application for controlling the playback of music data stored in the storage 103. At least one of the applications may be presorted in the storage 103. Also, at least one of the applications may be downloaded by the electronic apparatus 1 from another apparatus and stored in the storage 103.

The wireless communication unit 110 is equipped with an antenna 111. In the wireless communication unit 110, the antenna 111 can receive, via a base station or the like, a signal transmitted from a mobile phone different from the electronic apparatus 1 or a signal transmitted from a communication device such as a web server connected to the Internet. The wireless communication unit 110 can perform amplification and down-conversion on the reception signal, and output the resultant signal to the controller 100. The controller 100 can perform demodulation and the like on the input reception signal to acquire, for example, an image signal and a sound signal included in the reception signal. Further, the wireless communication unit 110 can perform up-conversion and amplification on a transmission signal generated by the controller 100 and including, for example, an image signal and a sound signal, and wirelessly transmit the processed transmission signal from the antenna 111. The transmission signal from the antenna 111 is received, via the base station or the like, by a mobile phone different from the electronic apparatus 1 or a communication device connected to the Internet or the like.

The display 220 includes a display panel 120 and the display area 20 of the front surface 1a of the electronic apparatus 1. The display 220 can display a variety of information in the display area 20. The display panel 120 is, for example, a liquid crystal display panel or an organic electroluminescent (EL) panel. The display panel 120 is controlled by the controller 100, so that the display panel 120 can display a variety of information, such as characters, signs, and graphics. The display panel 120 is opposed to the display area 20 in the apparatus case 2. The information displayed by the display panel 120 appears in the display area 20.

The touch panel 130 can detect an operation performed on the display area 20 with an operator, such as a finger. The touch panel 130 is, for example, a projected capacitive touch panel and is located behind the display area 20. When the user performs an operation on the display area 20 with an operator, such as a finger, the touch panel 130 inputs an electrical signal corresponding to the operation to the controller 100. The controller 100 specifies, based on the electrical signal input from the touch panel 130, the purpose of the operation performed on the display area 20, and performs processing appropriate to the purpose.

When receiving an operation performed by the user, the individual operation button 3 included in the operation button group 30 outputs, to the controller 100, an operation signal indicating that an operation is performed on the operation button 3. The controller 100 can thus determine whether an operation is performed on the individual operation button 3. Upon receipt of input of the operation signal, the controller 100 controls other constituent elements, so that the electronic apparatus 1 performs the functions assigned to the operation button 3 being the target of the operation.

The microphone 170 can convert a sound input from the outside of the electronic apparatus 1 into an electrical sound signal, and output the electrical sound signal to the controller 100. The sound from the outside of the electronic apparatus 1 is received by the microphone 170 through the microphone hole 23.

The speaker 160 is, for example, a dynamic speaker. The speaker 160 can convert an electrical sound signal from the controller 100 into a sound, and output the sound. The sound output from the speaker 160 is output from the speaker hole 22 to the outside. The volume of the sound output from the speaker hole 22 is set to be a degree such that the sound can be heard at a location away from the electronic apparatus 1.

The receiver 150 can output a received sound. The receiver 150 is, for example, a dynamic speaker. The receiver 150 can convert an electrical sound signal from the controller 100 into a sound, and output the sound. The sound output from the receiver 150 is output from the receiver hole 21 to the outside. The volume of the sound output from the receiver hole 21 is set to be lower than the volume of the sound output from the speaker hole 22. The volume of the sound output from the receiver hole 21 is set to a degree such that the user can hear the sound when moving the receiver hole 21 close to an ear. In place of the receiver 150, a vibrating element for vibrating the front surface portion of the apparatus case 2, such as a piezoelectric vibrating element, may be disposed, such that a sound is conducted from the front surface portion to the user.

The battery 200 can output power for the electronic apparatus 1. The battery 200 is, for example, a rechargeable battery. The power output from the battery 200 is supplied to the various constituent elements of the electronic apparatus 1, such as the controller 100 and the wireless communication unit 110.

The first camera 180 includes the imaging lens 181, an image sensor, and the like. The second camera 190 includes the imaging lens 191, an image sensor, and the like. The first camera 180 and the second camera 190 can individually capture an image of a subject in accordance with the control by the controller 100, create a still image or a moving image of the imaged subject, and output the resultant image to the controller 100.

The imaging lens 181 of the first camera 180 can be visually recognized form the front surface 1a of the electronic apparatus 1. The first camera 180 can thus capture an image of the subject in front of the front surface 1a (display area 20) of the electronic apparatus 1. The first camera 180 is also called an “in-camera”. The first camera 180 is hereinafter referred to as an “in-camera 180”.

The imaging lens 191 of the second camera 190 can be visually recognized from the rear surface 1b of the electronic apparatus 1. The second camera 190 can thus capture an image of the subject in front of the rear surface 1b of the electronic apparatus 1. The second camera 190 is also called an “out-camera”. The second camera 190 is hereinafter referred to as an “out-camera 190”. The in-camera 180 and the out-camera 190 are simply referred to as “cameras” unless there is a particular need to distinguish between them.

The fingerprint sensor 140 can detect the fingerprint of a finger that is in contact with the electronic apparatus 1. For example, the fingerprint sensor 140 detects the fingerprint of a finger that is in contact with the power button 3a. Specifically, the fingerprint sensor 140 detects the fingerprint of a finger that is in contact with the portion of the power button 3a showing on the apparatus case 2. The fingerprint sensor 140 can detect the fingerprint of a finger being in contact with the power button 3a and being at rest. The portion of the power button 3a showing on the apparatus case 2 is a fingerprint detection area. As will be described below, the controller 100 executes user authentication based on the fingerprint detection result obtained by the fingerprint sensor 140. For example, the fingerprint sensor 140 outputs, as the fingerprint detection result, a fingerprint image showing the detected fingerprint. The fingerprint sensor 140 employs, for example, a capacitive sensing method. The fingerprint sensor 140 may employ a sensing method other than the capacitive sensing method, such as an optical method. The fingerprint sensor 140 may detect the fingerprint of a finger with which a touch operation is performed on the power button 3a. The fingerprint sensor 140 may detect the fingerprint of a finger being in contact with the power button 3a and moving on the power button 3a. That is to say, the fingerprint sensor 140 may detect the fingerprint of a finger with which a slide operation is performed on the power button 3a. The fingerprint detected by the fingerprint sensor 140 is hereinafter also referred to as a “detected fingerprint”.

<Operation Modes of Electronic Apparatus>

The electronic apparatus 1 has, as operation modes, a sleep mode in which part of the functions of the electronic apparatus 1 including the display function is suspended and a normal mode in which the sleep mode is released. In the sleep mode, part of the constituents of the electronic apparatus 1 including, for example, the display panel 120, the touch panel 130, and the fingerprint sensor 140 are placed inactive. The amount of power consumed by the electronic apparatus 1 in the sleep mode is smaller than the amount of power consumed by the electronic apparatus 1 in the in the normal mode. The controller 100 controls a predetermined constituent of the electronic apparatus 1 to perform the setting of the operation mode of the electronic apparatus 1.

If a certain period of time has elapsed with no operation being performed on the electronic apparatus 1 in the normal mode, the operation mode shifts from the normal mode to the sleep mode. In response to an operation performed on the power button 3a in the normal mode, the operation mode shifts from the normal mode to the sleep mode. In response to an operation performed on the power button 3a in the sleep mode, the operation mode shifts from the sleep mode to the normal mode. This means that, in response to the operation performed on the power button 3a in the sleep mode, the functions of the electronic apparatus 1 that have been suspended at the shift to the sleep mode are restored. In response to an operation performed on the home button 3d in the sleep mode, the operation mode shifts from the sleep mode to the normal mode. In the sleep mode, the home button 3d functions as the operation button for releasing the sleep mode.

<Screen Displayed in Display Area>

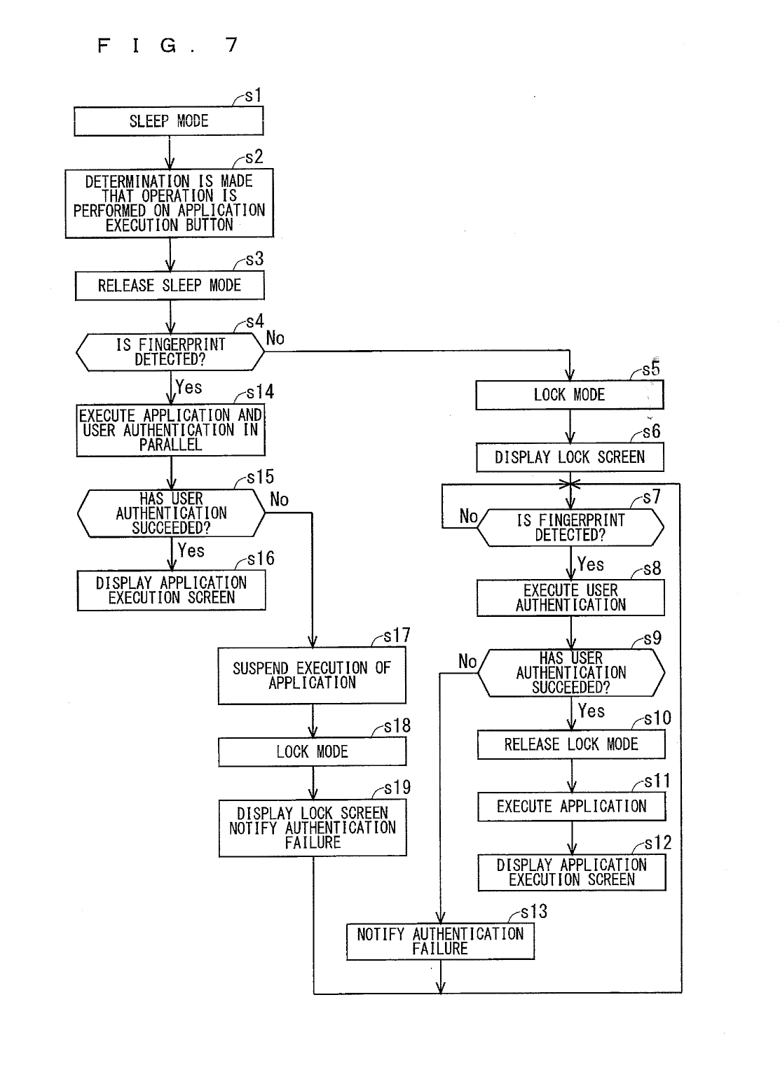

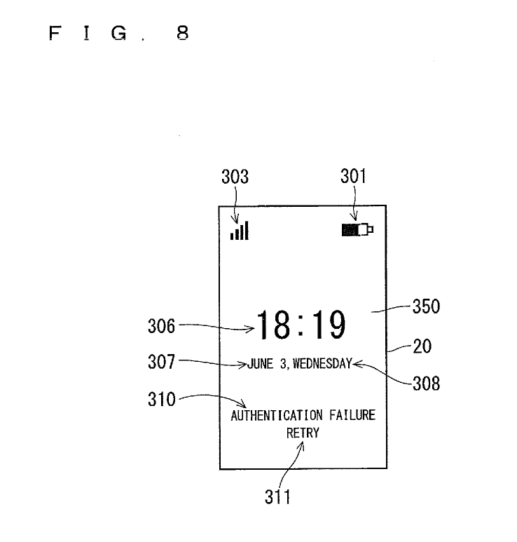

In the normal mode, various screens can be displayed in the display area 20. For example, a home screen or a lock screen is displayed in the display area 20. FIG. 5 is an illustration of an example of a home screen 300. FIG. 6 is an illustration of an example of a lock screen 350.

As illustrated in FIG. 5, the home screen 300 shows a remaining battery life icon 301 indicating the current charge status of the battery 200, a current time 302, and a reception condition icon (also referred to as a radio wave condition icon) 303 indicating the radio wave reception condition of the wireless communication unit 110. The home screen 300 also shows icons (hereinafter, referred to as “application icons”) 305 that are in a one-to-one correspondence with applications and used to execute corresponding applications. In an example illustrated in FIG. 5, ten application icons 305 are shown. When the user performs a predetermined operation (e.g., a tap operation) on one of the application icons 305, the controller 100 reads, from the storage 103, the application corresponding to the application icon 305 being the target of the operation, and executes the application. Thus, by performing an operation on the individual application icon 305, the user can cause the electronic apparatus 1 to execute the application corresponding to the application icon 305 being the target of the operation. When the user performs a tap operation on the application icon 305 corresponding to the browser, the electronic apparatus 1 opens the browser. When the user performs a tap operation on the application icon 305 corresponding to the camera application, the electronic apparatus 1 executes the camera application. The application icons 305 are software buttons displayed in the display area 20.

As illustrated in FIG. 6, similarly to the home screen 300, the lock screen 350 shows the remaining battery life icon 301 and the reception condition icon 303. The lock screen 350 also shows a current time 306, today's date 307, and today's day of week 308. The lock screen 350 shows the current time 306 in a position different from the position of the current time 302 on the home screen 300 and in a size larger than the current time 302.

Herein, the normal mode of the electronic apparatus 1 includes a lock mode in which the user is inhibited from causing the electronic apparatus 1 to execute the applications in the storage 103 except for the specific applications (e.g., the voice call application and the camera application) or to execute any of the applications in the storage 103. In the lock mode, the user is inhibited from instructing the electronic apparatus 1 to execute the individual applications in the storage 103 except for the specific applications or to execute any of the individual applications in the storage 103. The lock screen 350 is the screen for notifying that the electronic apparatus 1 is in the lock mode. The lock screen 350 is displayed in the display area 20 while the electronic apparatus 1 is in the lock mode.

When an operation is performed on the power button 3a or the home button 3d in the sleep mode, the sleep mode is released and the operation mode of the electronic apparatus 1 shifts to the lock mode, where the lock screen 350 is displayed in the display area 20.

When an operation is performed on the home button 3d of the electronic apparatus 1 operating in the normal mode, but not in the lock mode, the home screen 300 is displayed in the display area 20.

With the lock screen 350 being displayed in the display area 20, when the user performs a predetermined operation on the electronic apparatus 1, the electronic apparatus 1 releases the lock mode and replaces the lock screen 350 displayed in the display area 20 with another screen, such as the home screen 300. A state in which the lock mode is released during the operation in the normal mode is hereinafter referred to as an “unlocked mode”.

<User Authentication>

The controller 100 can execute user authentication based on the fingerprint detection result obtained by the fingerprint sensor 140. For example, the controller 100 executes user authentication while the electronic apparatus 1 is in the lock mode. If the user authentication performed by the controller 100 succeeds, the lock mode is released.

In executing user authentication, the controller 100 firstly extracts, from a fingerprint image output by the fingerprint sensor 140 as the fingerprint detection result, a feature point indicating the feature of the detected fingerprint shown in the fingerprint image. The feature point may include, for example, the positions of the endpoints and the branch points of a ridge line (projection) of the fingerprint and the thickness of the ridge line. Then, the controller 100 compares the extracted feature point with the reference feature point stored in the storage 103. The reference feature point is a feature point extracted from the fingerprint image showing the fingerprint of the authorized user (e.g., the owner of the electronic apparatus 1). If the extracted feature point resembles the reference feature point on the basis of the comparisons made between them, the controller 100 determines that the user authentication has succeeded. In other words, the controller 100 determines that the user whose fingerprint has been detected by the fingerprint sensor 140 is the authorized user. If the extracted feature point does not resemble the reference feature point, the controller 100 determines that the user authentication has failed. In other words, the controller 100 determines that the user whose fingerprint has been detected by the fingerprint sensor 140 is an unauthorized user.

As described above, the electronic apparatus 1 executes user authentication while operating in the lock mode. Thus, while the lock screen 350 is displayed, the authorized user can cause the electronic apparatus 1 to release the lock mode by touching the power button 3a with a finger in a manner not to place the power button 3a in the on state. When the lock mode is released, the lock screen 350 displayed in the display area 20 is replaced with a screen other than the lock screen 350 (e.g., the home screen).

The normal mode of the electronic apparatus 1 includes a fingerprint registration mode for registering the user's fingerprint in the electronic apparatus 1. When a predetermined operation is performed on the display area 20 in the unlocked mode, the electronic apparatus 1 operates in the fingerprint registration mode. When the authorized user puts a finger of his/her hand on the power button 3a during the operation in the fingerprint registration mode, the fingerprint sensor 140 detects the fingerprint of the finger and outputs a fingerprint image showing the detected fingerprint. The controller 100 extracts a feature point from the fingerprint image output from the fingerprint sensor 140 and causes the storage 103 to store the extracted feature point as the reference feature point. This means that the reference feature point indicating the feature of the fingerprint of the authorized user is stored in the storage 103. In other words, the fingerprint of the authorized user is registered in the electronic apparatus 1.

In some cases, the storage 103 can store a plurality of reference feature points. In this case, the controller 100 compares the extracted feature point with each of the plurality of reference feature points stored in the storage 103. If the plurality of reference feature points include the reference feature point that resembles the extracted feature point, the controller 100 determines that the user authentication has succeeded. If the extracted feature resembles none of the plurality of reference feature points, the controller 100 determines that the user authentication has failed.

The following description will be given assuming that the storage 103 stores, for example, the reference feature point corresponding to the thumb of the right hand of the authorized user and the reference feature point corresponding to the index finger of left hand of the authorized user. Thus, while holding the electronic apparatus 1 in the right hand, the authorized user can cause the electronic apparatus 1 to release the lock mode by touching the power button 3a of the electronic apparatus 1 with the thumb of the right hand. Also, while holding the electronic apparatus 1 in the left hand, the authorized user can cause the electronic apparatus 1 to release the lock mode by touching the power button 3a of the electronic apparatus 1 with the index finger of the left hand.

The reference feature point corresponding to the fingerprint of one of the fingers of the authorized user is hereinafter also referred to as the reference feature point of the relevant finger. The feature point extracted by the controller 100 from the fingerprint image obtained by the fingerprint sensor 140 is also referred to as an “extracted feature point”.

<Application Execution Button>

When an operation is performed on the application execution button 3b during the operation in the unlocked mode, the controller 100 reads and executes the application stored in the storage 103 and assigned to the application execution button 3b. Then, a screen corresponding to the application (hereinafter, referred to as an “application execution screen”), which is created in response to the execution of the application, is displayed in the display area 20.

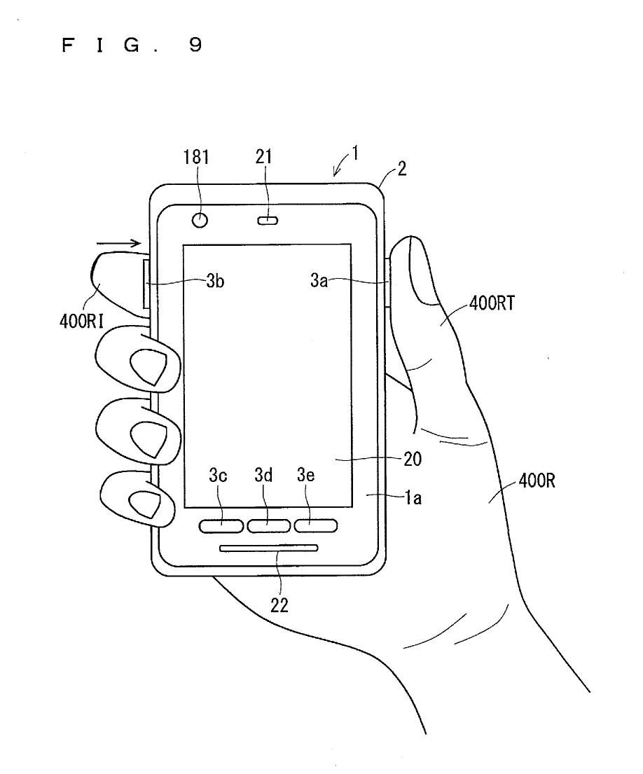

In response to an operation performed on the application execution button 3b during the operation in the sleep mode, the electronic apparatus 1 operates differently depending on whether the power button 3a is in contact with a finger. In other words, in response to an operation performed on the application execution button 3b during the operation in the sleep mode, the electronic apparatus 1 operates differently depending on whether a fingerprint is detected by the fingerprint sensor 140. The following will describe how the electronic apparatus 1 operates in response to an operation performed on the application execution button 3b during the operation in the sleep mode. FIG. 7 is an illustration of a flowchart the operation of the electronic apparatus 1.

As illustrated in FIG. 7, assuming that the electronic apparatus 1 operates in the sleep mode in Step s1, if the controller 100 determines, in Step s2, that an operation is performed on the application execution button 3b, the sleep mode is released in Step s3. Then, in Step s4, the controller 100 determines whether a fingerprint is detected by the fingerprint sensor 140. That is to say, the controller 100 determines whether the power button 3a is in contact with a finger. The controller 100 can determine that the power button 3a is contact with the finger, regardless of whether the power button 3a is pressed with the finger of the user.

If the controller 100 determines, in Step s4, that no fingerprint is detected by the fingerprint sensor 140 (that the power button 3a is not in contact with a finger), in Step s5, the operation mode of the electronic apparatus 1 shifts to the lock mode, and in Step s6, the controller 100 causes the display 220 to display the lock screen. The lock screen may be similar to the screen illustrated in FIG. 6, which is not limited thereto. For example, the lock screen displayed in Step s6 may include a string “Unlock This Device”.

When the lock screen is displayed, in Step s7, the controller 100 enters the fingerprint detection wait state and determines whether a fingerprint is detected by the fingerprint sensor 140. If the controller 100 determines that a fingerprint is detected by the fingerprint sensor 140, in Step s8, the controller 100 executes user authentication, similarly to the above. The controller 100 repeatedly executes Step s7 until it determines that a fingerprint is detected by the fingerprint sensor 140.

Upon completion of the user authentication in Step s8, the controller 100 determines, in Step s9, whether the user authentication has succeeded. If the controller 100 determines that the user authentication has succeeded, the controller 100 releases the lock mode in Step s10 and executes, in Step s11, the application assigned to the application execution button 3b being the target of the operation. Then, the controller 100 causes the display 220 to display, in place of the lock screen, the application execution screen corresponding to the running application. In the case where the PTT application is assigned to the application execution button 3b, the application execution screen corresponding to the PTT application is displayed in place of the lock screen.

If the controller 100 determines, in Step s9, that the user authentication has failed, in Step s13, the controller 100 causes the display 220 to display the lock screen including authentication failure notification information for notifying the user authentication failure. FIG. 8 is an illustration of an example of the lock screen 350 including authentication failure notification information 310. In the example of FIG. 8, the string “Authentication Failure” is displayed as the authentication failure notification information 310. As illustrated in FIG. 8, the lock screen 350 displayed in Step s13 may include information 311 for instructing the user to touch the power button 3a again.

Subsequent to Step s13, the controller 100 enters the fingerprint detection wait state again and executes Step s7. From that time forward, the electronic apparatus 1 operates similarly to the above.

If the controller 100 determines, in Step s4, that a fingerprint is detected by the fingerprint sensor 140 (that the power button 3a is in contact with a finger), in Step s14, the controller 100 starts executing user authentication and the application assigned to the application execution button 3b, thus executing user authentication and the application in parallel. In Step s14, it is only required that the user authentication and the application be executed in parallel. The application may be started before or after the user authentication, or may be started concurrently with the user authentication.

Upon completion of the user authentication in Step s14, in Step s15, the controller 100 determines whether the user authentication has succeeded. If the controller 100 determines that the user authentication has succeeded, in Step s16, the controller 100 causes the display 220 to display the application execution screen corresponding to the running application. Consequently, the state of displaying no image in the display area 20 shifts to the state of displaying the application execution screen without going into the state of displaying the lock screen.

If the controller 100 determines that the user authentication has failed, in Step s17, the controller 100 suspends the execution of the application assigned to the application execution button 3b, and in Step s18, the operation mode of the electronic apparatus 1 shifts to the lock mode. When the operation mode of the electronic apparatus 1 shifts to the lock mode, in Step s19, the controller 100 causes the display 220 to display the lock screen including the authentication failure notification information as in Step s13. Consequently, the state of displaying no image in the display area 20 shifts to the state of displaying the lock screen without going into the state of displaying the application execution screen.

Subsequent to Step s19, the controller 100 enters the fingerprint detection wait state and executes Step s7. From that time forward, the electronic apparatus 1 operates similarly to the above.

As described above, with no fingerprint being detected by the fingerprint sensor 140, when an operation is performed on the application execution button 3b, the lock screen is displayed on the electronic apparatus 1. Thus, when the user whose fingers are not in contact with the power button 3a performs an operation on the application execution button 3b, the electronic apparatus 1 displays the lock screen. When the fingerprint sensor 140 detects a fingerprint in the state in which the lock screen is displayed, user authentication is started in the electronic apparatus 1. If the user authentication succeeds, the application assigned to the application execution button 3b is executed. Thus, when the user touches, with a finger, the power button 3a of the electronic apparatus 1 on which the lock screen is displayed, the electronic apparatus 1 starts user authentication. If the user authentication succeeds, the electronic apparatus 1 executes the application assigned to the application execution button 3b.

With a fingerprint being detected by the fingerprint sensor 140, when an operation is performed on the application execution button 3b, the controller 100 executes user authentication and the application assigned to the application execution button 3b in electronic apparatus 1. Thus, when the user whose finger is in contact with the power button 3a performs an operation on the application execution button 3b, the controller 100 executes user authentication and the application assigned to the application execution button 3b.

As described above, in the case where the user whose fingers are not in contact with the power button 3a performs an operation on the application execution button 3b, the user needs to take the following actions such that the electronic apparatus 1 can execute user authentication and the application assigned to the application execution button 3b. Firstly, the user performs an operation on the application execution button 3b. Then, after the lock screen is displayed on the electronic apparatus 1, the user needs to touch the power button 3a with a finger. In other words, in order to cause the electronic apparatus 1 to execute the user authentication and the application assigned to the application execution button 3b, the user needs to touch the power button 3a with a finger after performing an operation on the application execution button 3b. This means that two operations need to be performed on the electronic apparatus 1.

Meanwhile, in the case where the user whose finger is in contact with the power button 3a performs an operation on the application execution button 3b, user authentication and the application assigned to the application execution button 3b are executed in the electronic apparatus 1 in response to the operation performed on the application execution button 3b. In other words, in order to cause the electronic apparatus 1 to execute user authentication and the application assigned to the application execution button 3b, the user only needs to perform an operation on the application execution button 3b while touching the power button 3a with a finger. This means that only one operation needs to be performed on the electronic apparatus 1. This improves the operability of the electronic apparatus 1.

When the user whose finger is in contact with the power button 3a performs an operation on the application execution button 3b, the electronic apparatus 1 executes, in parallel, user authentication and the application assigned to the application execution button 3b. Thus, the electronic apparatus 1 can display the application execution screen immediately after the user authentication succeeds.

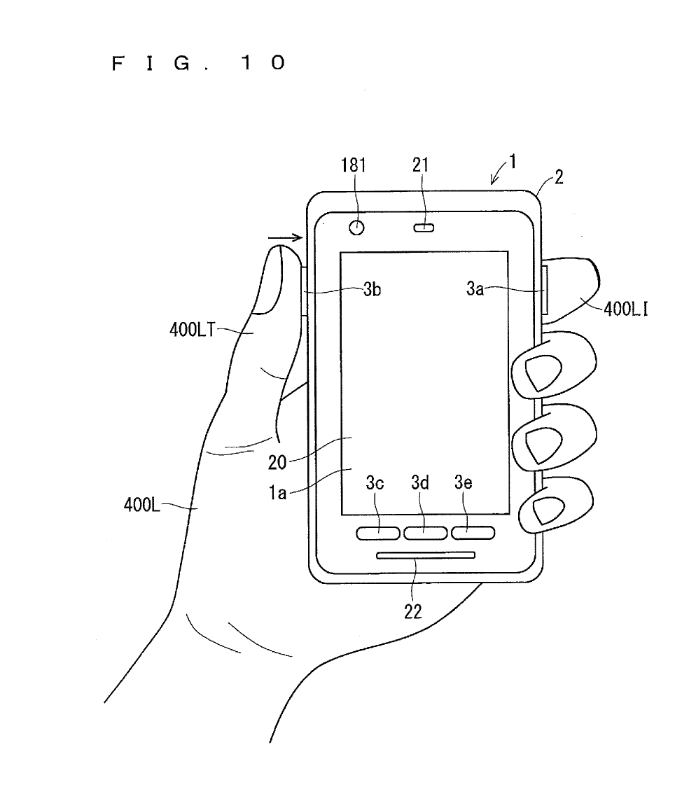

As described above, the storage 103 stores the reference feature point corresponding to the fingerprint of the thumb of the right hand of the user. As illustrated in FIG. 9, when the authorized user holding the electronic apparatus 1 in the sleep mode in a right hand 400R and touching the power button 3a with a right-hand thumb 400RT performs an operation on the application execution button 3b with a right-hand index finger 400RI, the state of displaying no image in the display area 20 shifts to the state of displaying the application execution screen without passing through the state of displaying the lock screen.

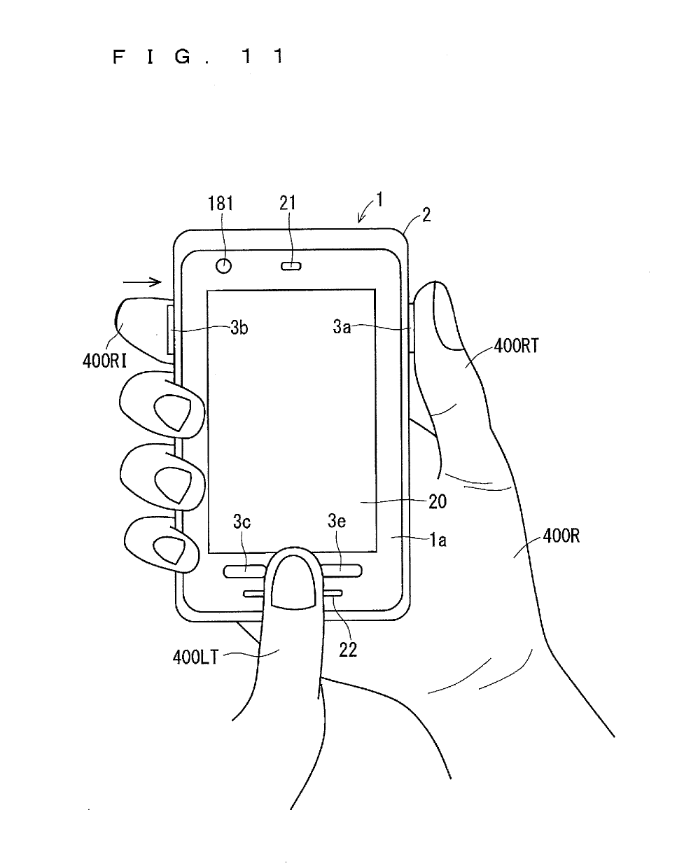

As described above, the storage 103 also stores the reference feature point corresponding to the fingerprint of the index finger of the left hand of the authorized user. As illustrated in FIG. 10, when the authorized user holding the electronic apparatus 1 in the sleep mode in a left hand 400L and touching the power button 3a with a left-hand index finger 400LI performs an operation on the application execution button 3b with a left-hand thumb 400LT, the state of displaying no image in the display area 20 shifts to the state of displaying the application execution screen without passing through the state of displaying the lock screen.

In one example, the operation button 3a being the target of fingerprint detection, in which the fingerprint sensor 140 detects the fingerprint of a finger that is in contact with the operation button 3a, is located in the right side surface 1c of the electronic apparatus 1. Thus, as illustrated in FIGS. 9 and 10 mentioned above, the user can easily perform an operation on the operation button 3a with one hand in which the user holds the electronic apparatus 1. The user can thus easily cause the electronic apparatus 1 to execute user authentication while holding the electronic apparatus 1 in one hand.

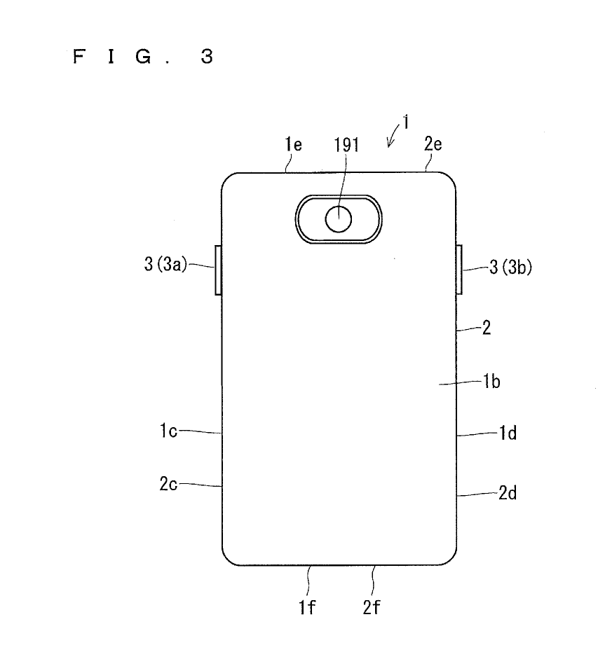

In this example, the operation button 3a is located in the right side surface 1c of the electronic apparatus 1 and the application execution button 3b is located in the left side surface 1d of the electronic apparatus 1. As illustrated in FIGS. 9 and 10 mentioned above, the user can thus easily perform operations on the operation button 3a and the application execution button 3b at the same time with one hand in which the user holds the electronic apparatus 1. The user can thus easily cause the electronic apparatus 1 to execute user authentication and the application while holding the electronic apparatus 1 in one hand. As illustrated in, for example, FIG. 2, the operation button 3a and the application execution button 3b are preferably opposed to each other in the lateral direction (transverse direction) of the electronic apparatus 1.

In one example, the operation button 3a being the target of fingerprint detection, in which the fingerprint sensor 140 detects the fingerprint of a finger that is in contact with the operation button 3a, protrudes from the surface of the electronic apparatus 1. The user can thus easily specify the position of the fingerprint detection area of the electronic apparatus 1. In using the electronic apparatus 1 in, for example, a dark place, the user can easily specify the position of the fingerprint detection area, because the operation button 3a protrudes from the surface of the electronic apparatus 1. Also, the user who wants to use the electronic apparatus 1 immediately after taking it out of a pocket or a bag can easily specify the position of the fingerprint detection area, because the operation button 3a protrudes from the front surface of the electronic apparatus 1.

In the examples of FIGS. 9 and 10, the user touches the power button 3a with a finger of one of the right and left hands, and operates the application execution button 3b with another finger of the same hand. Alternatively, the user may touch the power button 3a with a finger of one of the right and left hands, and operate the application execution button 3b with a finger of the other hand. For example, the user may perform an operation on the application execution button 3b with the left-hand index finger while touching the power button 3a with the right-hand thumb.

A plurality of applications may be assigned to the application execution button 3b. In this case, the plurality of applications assigned to the application execution button 3b are brought into one-to-one correspondence with different kinds of operations to be performed on the application execution button 3b. In response to an operation performed on the application execution button 3b, the controller 100 executes the application corresponding to the relevant kind of operation. By performing a predetermined operation on the display area 20, the user can cause the electronic apparatus 1 to assign the plurality of applications to the application execution button 3b and to bring the plurality of applications into one-to-one correspondence with different kinds of operations to be performed on the application execution button 3b.

Assume that the browser and the e-mail application are assigned to the application execution button 3b. In this case, by performing the predetermined operation on the display area 20, the user causes the electronic apparatus 1 to bring the browser and the e-mail application into one-to-one correspondence with, for example, a short press operation and a long press operation to be performed on the application execution button 3b. The short press operation refers to the operation of pressing the operation button for a short period of time. The long press operation refers to the operation of pressing the operation button for a long period of time. In response to the short press operation performed on the application execution button 3b, the controller 100 opens the browser. In response to the long press operation performed on the application execution button 3b, the controller 100 executes the e-mail application.

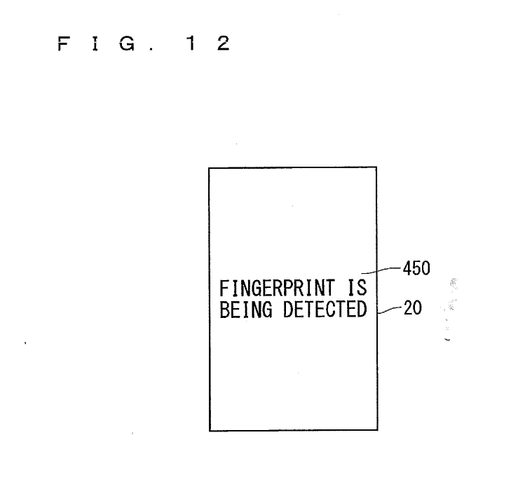

In one example above, the fingerprint sensor 140 detects the fingerprint of a finger that is in contact with the power button 3a. Alternatively, the fingerprint sensor 140 may detect the fingerprint of a finger that is in contact with another hardware button. For example, the fingerprint sensor 140 may detect the fingerprint of a finger that is in contact with the home button 3d. In this case, as illustrated in FIG. 11, when the authorized user whose finger is in contact with the home button 3d performs an operation on the application execution button 3b, the electronic apparatus 1 starts executing user authentication and the application assigned to the application execution button 3b. If the user authentication succeeds, the application execution screen is displayed. In the example of FIG. 11, the authorized user touches the home button 3d with the left-hand thumb 400LT.

In one example above, the power button 3a is located in the right side surface 1c of the electronic apparatus 1 and the application execution button 3b is located in the left side surface 1d of the electronic apparatus 1. Alternatively, the power button 3a may be located in the left side surface 1d and the application execution button 3b may be located in the right side surface 1c.

In a case where a hardware button other than the power button 3a is located in the right side surface 1c of the electronic apparatus 1, the fingerprint sensor 140 may detect the fingerprint of the finger that is in contact with the hardware button. In this case, when the user whose finger is in contact with the hardware button performs an operation on the application execution button 3b, the controller 100 executes user authentication and the application assigned to the application execution button 3b.

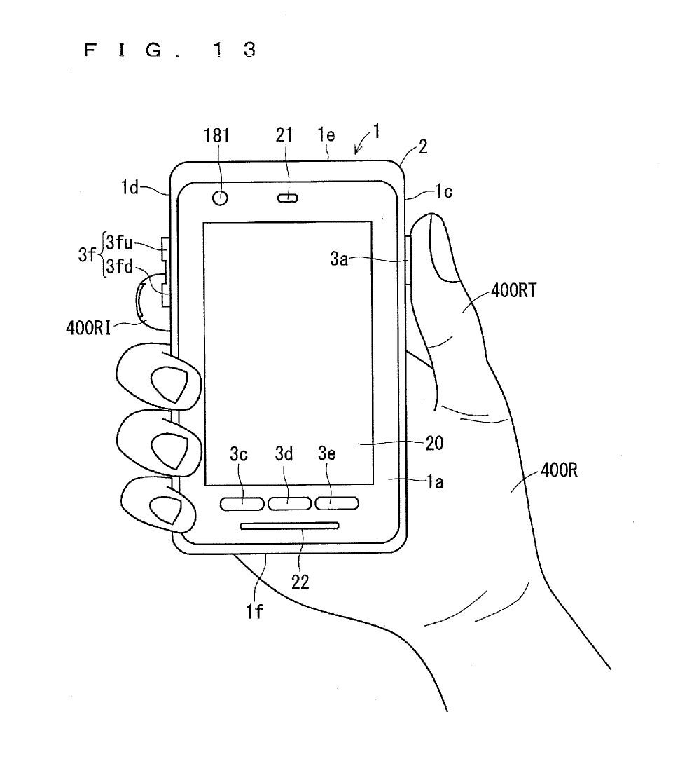

In a case where user authentication in the electronic apparatus 1 takes a little longer, the electronic apparatus 1 may display, at the start of the user authentication in Step s14 above, a notification screen 450 for notifying that the user authentication is in execution. FIG. 12 is an illustration of an example of the notification screen 450. In the example of FIG. 12, the notification screen 450 shows the string “Fingerprint is Being Detected”.

<Various Kinds of Modifications>

The following will describe various kinds of modifications of the electronic apparatus 1.

<First Modification: Volume Buttons>

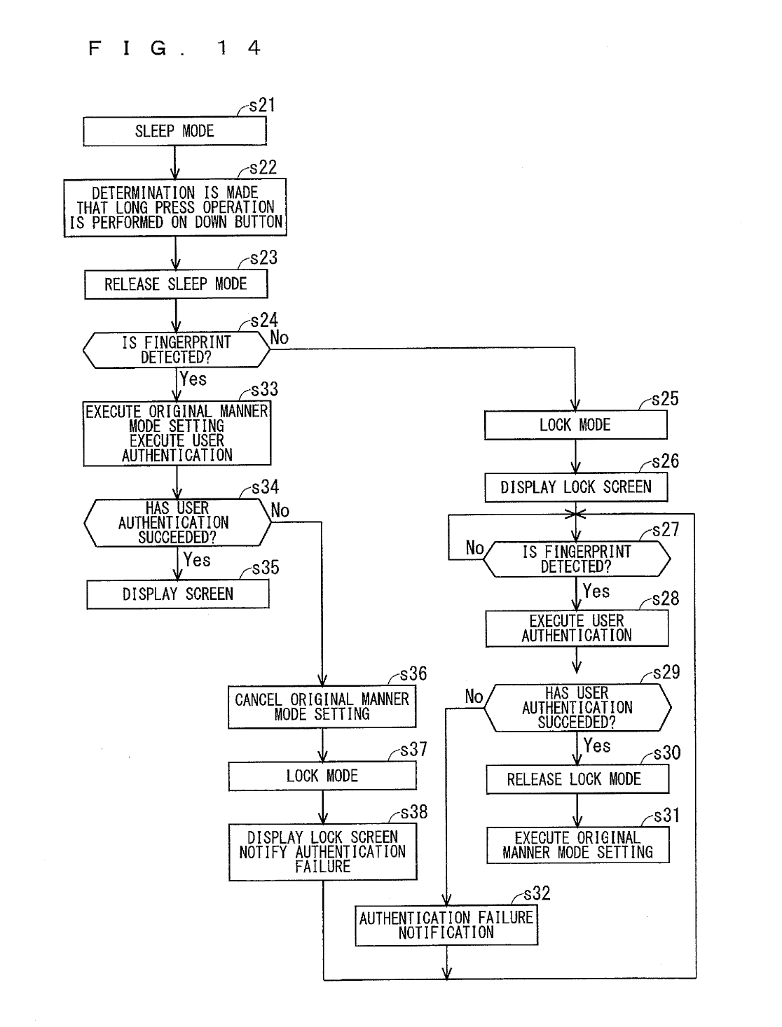

FIG. 13 is an illustration of the state in which the electronic apparatus 1 according on one modification is held in the right hand 400R of the user. As illustrated in FIG. 13, the electronic apparatus 1 according to one modification is obtained by replacing the application execution button 3b in the left side surface 1d of the above-mentioned electronic apparatus 1 with volume buttons 3f.

The volume buttons 3f includes a volume up button 3fu and a volume down button 3fd. The volume up button 3fu is assigned a volume up function of increasing the set value of level of sounds output from the receiver hole 21 and the speaker hole 22. In response to an operation performed on the volume up button 3fu of the electronic apparatus 1 operating in the unlocked mode, the controller 100 increases the set value of level of sounds output from the receiver 150 and the speaker 160.

The volume down button 3fd is assigned a volume down function of reducing the set value of level of sounds output from the receiver 150 and the speaker 160 and an original manner mode setting function of setting the operation mode of the electronic apparatus 1 to an original manner mode. The volume down function is brought into correspondence with a short press operation to be performed on the volume down button 3fd, and the original manner mode setting function is brought into correspondence with a long press operation to be performed on the volume down button 3fd. The controller 100 reduces the set value of level of sounds output from the receiver 150 and the speaker 160 in response to a short press operation performed on the volume down button 3fd of the electronic apparatus 1 operating in the unlocked mode. In response to a long press operation performed on the volume down button 3fd of the electronic apparatus 1 operating in the unlocked mode, the operation mode of the electronic apparatus 1 is set to the original manner mode.

The original manner mode herein refers to the mode in which the electronic apparatus 1 operates in accordance with the set values designated by the user for a plurality of setting options of the electronic apparatus 1 including the setting of level of sounds output from the electronic apparatus 1. In the original manner mode, various kinds of sound levels, such as an incoming e-mail reception sound level, an incoming voice call reception sound level, and an alarm sound level for an alarm function, are set at values designated by the user.

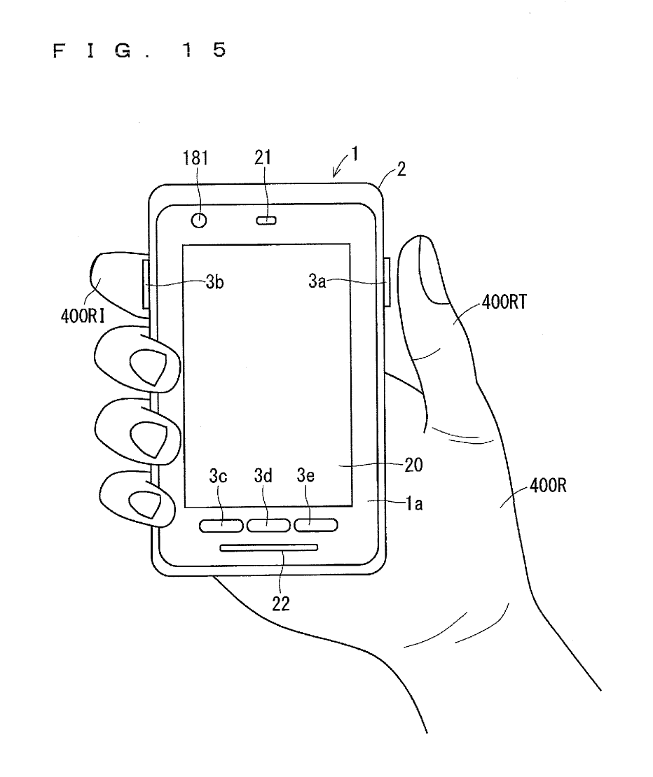

In response to a long press operation performed on the volume down button 3fd during the operation in the sleep mode, the electronic apparatus 1 operates differently depending on whether the power button 3a is in contact with a finger. FIG. 14 is an illustration of a flowchart showing how the electronic apparatus 1 operates in response to a long press operation performed on the volume down button 3fd during the operation in the sleep mode. The volume down button 3fd is hereinafter referred to as a “down button 3fd”.

As illustrated in FIG. 14, assuming that the electronic apparatus 1 operates in the sleep mode in Step s21, if the controller 100 determines, in Step s22, that a long press operation is performed on the down button 3fd, the sleep mode is released in Step s23. Then, in Step s24, the controller 100 determines whether a fingerprint is detected by the fingerprint sensor 140. That is to say, the controller 100 determines whether the power button 3a is in contact with a finger. The controller 100 can determine that the power button 3a is in contact with the finger of the user, regardless of whether the power button 3a is pressed with the finger of the user.

If the controller 100 determines, in Step s24, that no fingerprint is detected by the fingerprint sensor 140, in Step s25, the operation mode of the electronic apparatus 1 shifts to the lock mode, and in Step s26, the controller 100 causes the display 220 to display the lock screen. This lock screen is similar to the lock screen displayed in Step s6 above.

When the lock screen is displayed, in Step s27, the controller 100 enters the fingerprint detection wait state and determines whether a fingerprint is detected by the fingerprint sensor 140. If the controller 100 determines that a fingerprint is detected by the fingerprint sensor 140, the controller 100 executes user authentication in Step s28. The controller 100 repeatedly executes Step s27 until it determines that a fingerprint is detected by the fingerprint sensor 140.

Upon completion of the user authentication in Step s28, the controller 100 determines, in Step s29, whether the user authentication has succeeded. If the controller 100 determines that the user authentication has succeeded, in Step s30, the controller 100 releases the lock mode, and in Step s31, the controller 100 sets the operation mode of the electronic apparatus 1 to the original manner mode. A predetermined screen (e.g., the home screen) is displayed on the electronic apparatus 1.

If the controller 100 determines that the user authentication has failed, in Step s32, the controller causes the display 220 to display the lock screen including the authentication failure notification information for notifying the user authentication failure. This lock screen is similar to the lock screen displayed in Step s13 above.

Subsequent to Step s32, the controller 100 enters the fingerprint detection wait state and executes Step s27. From that time forward, the electronic apparatus 1 operates similarly to the above.

If a determination is made, in Step s24, that a fingerprint is detected by the fingerprint sensor 140, in Step s33, the operation mode of the electronic apparatus 1 is set to the original manner mode and user authentication is executed. In Step s33, the user authentication may be started after the operation mode of the electronic apparatus 1 is set to the original manner mode, or the operation mode of the electronic apparatus 1 may be set to the original manner mode after the user authentication is started. The user authentication may be started concurrently with the original manner mode setting.

Upon completion of the user authentication in Step s33, in Step s34, the controller 100 determines whether the user authentication has succeeded. If the controller 100 determines that the user authentication has succeeded, in Step s35, the controller 100 causes the display 220 to display a predetermined screen. For example, the home screen is displayed in Step s35.

If the controller 100 determines that the user authentication has failed, in Step s36, the controller 100 cancels the original manner mode setting, and in Step s37, the operation mode of the electronic apparatus 1 is set to the lock mode. If the operation mode of the electronic apparatus 1 shifts to the lock mode, in Step s38, the controller 100 causes the display 220 to display the lock screen including the authentication failure notification information as in Step s32. Consequently, the state of displaying no image in the display area 20 directly shifts to the state of displaying the lock screen.

Subsequent to Step s38, the controller 100 enters the fingerprint detection wait state and executes Step s27. From that time forward, the electronic apparatus 1 operates similarly to the above.

As described above, with no fingerprint being detected by the fingerprint sensor 140, when a long press operation is performed on the down button 3fd, the lock screen is displayed on the electronic apparatus 1. Thus, when the user whose fingers are not in contact with the power button 3a performs a long press operation on the down button 3fd, the electronic apparatus 1 displays the lock screen. When the fingerprint sensor 140 detects a fingerprint in the state in which the lock screen is displayed, the electronic apparatus 1 starts user authentication, and if the user authentication succeeds, the operation mode is set to the original manner mode. Thus, when the user touches, with a finger, the power button 3a of the electronic apparatus 1 on which the lock screen is displayed, the electronic apparatus 1 starts user authentication, and if the user authentication succeeds, the electronic apparatus 1 sets the operation mode to the original manner mode. In other words, when the user touches, with a finger, the power button 3a of the electronic apparatus 1 on which the lock screen is displayed, the electronic apparatus 1 starts user authentication, and if the user authentication succeeds, the electronic apparatus 1 executes the function assigned to the down button 3fd.

With a fingerprint being detected by the fingerprint sensor 140, when a long press operation is performed on the down button 3fd, the controller 100 executes user authentication and the original manner mode setting in the electronic apparatus 1. When the user whose finger is in contact with the power button 3a performs an operation on the down button 3fd, the controller 100 executes user authentication and the original manner mode setting. In other words, when the user whose finger is in contact with the power button 3a performs an operation on the down button 3fd, the controller 100 executes user authentication and the function assigned to the down button 3fd being the target of the operation.

As described above, assuming that the user whose fingers are not in contact with the power button 3a performs an operation on the down button 3fd, the user needs to take the following actions such that the electronic apparatus 1 can execute user authentication and the original manner mode setting. Firstly, the user performs an operation on the down button 3fd. Then, after the lock screen is displayed on the electronic apparatus 1, the user needs to touch the power button 3a with a finger.

Assuming that the user whose finger is in contact with the power button 3a performs an operation on the down button 3fd, meanwhile, user authentication and the original manner mode setting are executed in the electronic apparatus 1 in response to an operation performed on the down button 3fd. In other words, in order to cause the electronic apparatus 1 to execute user authentication and the original manner mode setting, the user only needs to perform an operation on the down button 3fd while touching the power button 3a with a finger. This means that only one operation needs to be performed on the electronic apparatus 1. This improves the operability of the electronic apparatus 1.

Assume that the storage 103 stores the reference feature point corresponding to the fingerprint of the thumb of the right hand of the authorized user. As illustrated in FIG. 13, when the authorized user holding the electronic apparatus 1 in the sleep mode in the right hand 400R and touching the power button 3a with the right-hand thumb 400RT performs a long press operation on the down button 3fd with the right-hand index finger 400RI, the electronic apparatus 1 sets the operation mode to the original manner mode without going into the lock mode.

<Second Modification: Canceling Execution of Function Assigned to Operation Button>

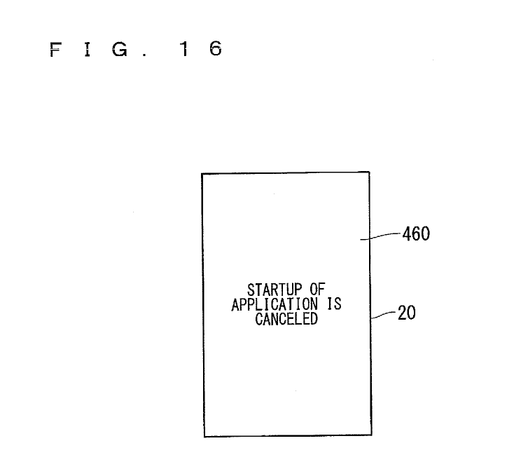

As illustrated in FIG. 15, in a case where the finger is moved off the power button 3a during the execution of the user authentication started in Step s14 in FIG. 7 mentioned above, the controller 100 may cancel the execution of the application assigned to the application execution button 3b. In other words, when the fingerprint sensor 140 fails to detect a fingerprint during the execution of user authentication, the controller 100 may cancel the execution of the function assigned to the application execution button 3b. The controller 100 may cause the display 220 to display a notification screen 460 for notifying the user that the execution of the application assigned to the application execution button 3b is canceled. FIG. 16 is an illustration of an example of the notification screen 460. When the execution of the application is canceled, Steps s5 and s6 are executed in the electronic apparatus 1, where the lock screen is displayed. For example, the display 220, which may be configured to display the notification screen, displays the lock screen after displaying the notification screen 460 for a certain period of time. Then, the electronic apparatus 1 performs Step s7 and subsequent steps, similarly to the above. FIG. 15 is an illustration of the state in which the right-hand thumb 400RT being in contact with the power button 3a is moved off the power button 3a.

As described above, in the case where the finger is moved off the power button 3a during the execution of user authentication, the controller 100 cancels the execution of the application assigned to the application execution button 3b. Thus, the user can cause the electronic apparatus 1 to cancel the execution of the application assigned to the application execution button 3b being the target of the operation by moving the finger off the power button 3a during the execution of user authentication. In other words, the user can cancel the operation performed on the application execution button 3b by moving the finger off the power button 3a during the execution of user authentication. Thus, through a simple operation, the user can thus cancel the operation performed on the application execution button 3b. This improves the operability of the electronic apparatus 1.

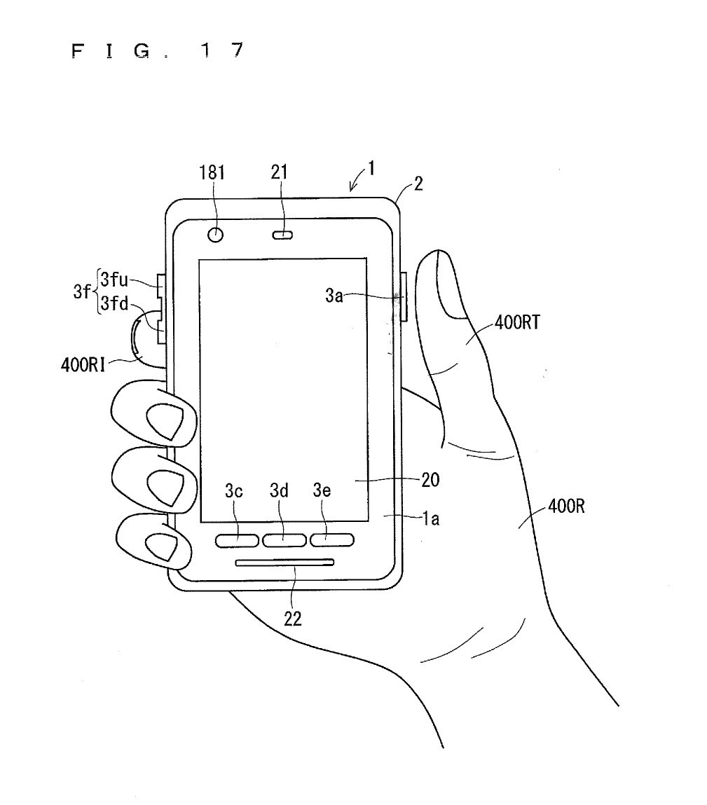

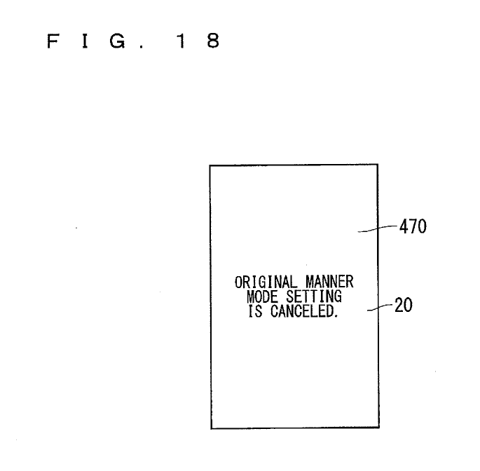

Similarly, as illustrated in FIG. 17, in the case where the finger is moved off the power button 3a during the execution of the user authentication started in Step s33 in FIG. 14 mentioned above, the controller 100 may cancel the original manner mode setting. In other words, when the fingerprint sensor 140 fails to detect a fingerprint during the execution of the user authentication, the controller 100 may cancel the execution of the function assigned to the down button 3fd. The controller 100 may cause the display 220 to display a notification screen 470 for notifying the user that the original manner mode setting is canceled. FIG. 18 is an illustration of an example of the notification screen 470. When the original manner mode setting is canceled, Steps s25 and s26 are executed in the electronic apparatus 1, where the lock screen is displayed. For example, the display 220, which may be configured to display the notification screen 470, displays the lock screen after displaying the notification screen 470 for a certain period of time. Then, the electronic apparatus 1 performs Step s27 and the subsequent steps, similarly to the above. FIG, 17 is an illustration of the state in which the right-hand thumb 400RT being in contact with the power button 3a is moved off the power button 3a.

As described above, in the case where the finger is moved off the power button 3a during the execution of user authentication, the controller 100 cancels the original manner mode setting. Thus, the user can cause the electronic apparatus 1 to cancel the original manner mode setting by moving the finger off the power button 3a during the execution of user authentication. In other words, the user can cancel the operation performed on the down button 3fd by moving the finger off the power button 3a during the execution of user authentication. Thus, through a simple operation, the user can cancel the operation performed on the down button 3fd. This improves the operability of the electronic apparatus 1.

<Third Modification: Detecting How Electronic Apparatus is Held>

In the electronic apparatus 1, the controller 100 may determine how the user holds the electronic apparatus 1 based on the fingerprint detection result obtained by the fingerprint sensor 140.

As in one example above, in the case where the storage 103 stores the reference feature point of the right-hand thumb and the reference feature point of the left-hand index finger, the controller 100 can determine in which hand, right or left, the user holds the electronic apparatus 1 based on the fingerprint detection result obtained by the fingerprint sensor 140. Specifically, if the feature point (extracted feature point) extracted from the fingerprint image output from the fingerprint sensor 140 resembles the reference feature point of the right-hand thumb stored in the storage 103, the controller 100 determines that the user (authorized user) holds the electronic apparatus 1 in the right hand as illustrated in FIG. 9 mentioned above. If the extracted feature point resembles the reference feature point of the left-hand index finger stored in the storage 103, the controller 100 determines that the user (authorized user) holds the electronic apparatus 1 in the left hand as illustrated in above-mentioned FIG. 10.

Also, the controller 100 can determine which one of the rear surface 1b side and the front surface 1a side of the electronic apparatus 1 faces one hand in which the user holds the electronic apparatus 1. That is to say, the controller 100 can determine which one of the rear surface 1b and the front surface 1a of the electronic apparatus 1 is opposed to the palm of one hand in which the user holds the electronic apparatus 1. This will be described below in detail.

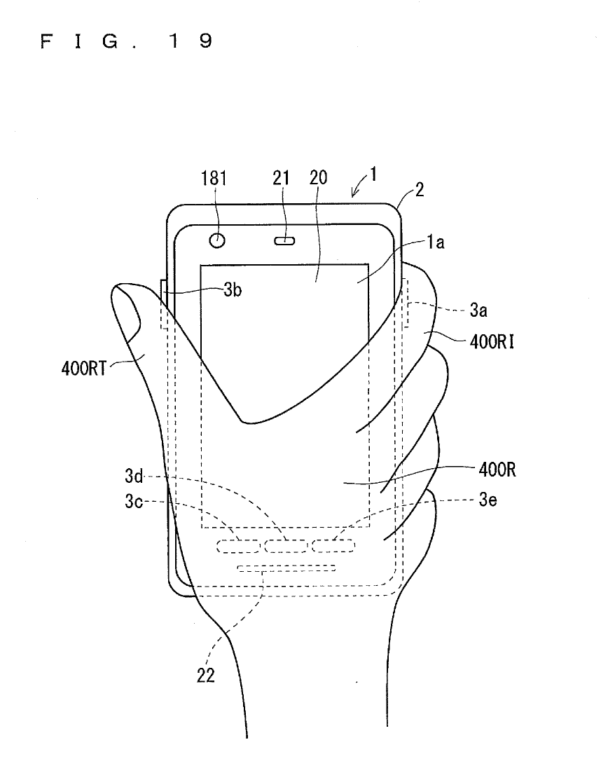

The figures such as FIGS. 9 and 10 mentioned above illustrate the state in which the user holds the electronic apparatus 1 in one hand facing the rear surface 1b side of the apparatus. FIG. 19 is an illustration of the state in which the user holds the electronic apparatus 1 in one hand (specifically, the right hand 400R) facing the front surface 1a side of the electronic apparatus 1. In the example of FIG. 19, the user performs an operation on the application execution button 3b with the right-hand thumb 400RT while touching the power button 3a with, for example, the right-hand index finger 400RI.

In the case where the controller 100 is configured to determine which one of the rear surface 1b side and the front surface 1a side of the electronic apparatus 1 faces one hand in which the user holds the electronic apparatus 1, the storage 103 stores, for example, the reference feature point of the right-hand thumb and the reference feature point of the right-hand index finger assuming that that the user holds the electronic apparatus 1 in the right hand. If the extracted feature point resembles the reference feature point of the right-hand thumb stored in the storage 103, the controller 100 determines that the user (authorized user) holds the electronic apparatus 1 in one hand facing the rear surface 1b side of the electronic apparatus 1 as illustrated in FIG. 9. If the extracted feature point resembles the reference feature point of the right-hand index finger stored in the storage 103, the controller 100 determines that the user (authorized user) holds the electronic apparatus 1 in one hand facing the front surface 1a side of the electronic apparatus 1 as illustrated in FIG. 19.

Alternatively, the storage 103 may store the reference feature point of the left-hand thumb and the reference feature point of the left-hand index finger assuming that the user holds the electronic apparatus 1 in the left hand. In this case, if the extracted feature point resembles the reference feature point of the left-hand index finger stored in the storage 103, the controller 100 determines that the user holds the electronic apparatus 1 in one hand facing the rear surface 1b side of the electronic apparatus 1 as illustrated in FIG. 10. If the extracted feature point resembles the reference feature point of the left-hand thumb stored in the storage 103, the controller 100 determines that the user holds the electronic apparatus 1 in one hand facing the front surface 1a side of the electronic apparatus 1.

Still alternatively, the storage 103 may store the reference feature point of the right-hand thumb, the reference feature point of the right-hand index finger, the reference feature point of the left-hand thumb, and the reference feature point of the left-hand index finger in order to determine in which hand, right or left, the user holds the electronic apparatus 1. If the extracted feature point resembles the reference feature point of the right-hand thumb stored in the storage 103, the controller 100 determines that the user holds the electronic apparatus 1 in the right hand facing the rear surface 1b side of the electronic apparatus 1. In this case, if the extracted feature point resembles the reference feature point of the right-hand index finger stored in the storage 103, the controller 100 determines that the user holds the electronic apparatus 1 in the right hand facing the front surface 1a side of the electronic apparatus 1. If the extracted feature point resembles the reference feature point of the left-hand index finger stored in the storage 103, the controller 100 determines that the user holds the electronic apparatus 1 in the left hand facing the rear surface 1b side of the electronic apparatus 1. If the extracted feature point resembles the reference feature point of the left-hand thumb stored in the storage 103, the controller 100 determines that the user holds the electronic apparatus 1 in the left hand facing the front surface 1a side of the electronic apparatus 1.

In the case where the controller 100 is configured to determine how the user holds the electronic apparatus 1, the fingerprint sensor 140 may detect not only the fingerprint of the finger being in contact with the power button 3a but also the fingerprint of the finger being in contact with the operation button 3b. In this case, the controller 100 determines how the user holds the electronic apparatus 1 based on fingerprint images showing the fingerprints detected by the fingerprint sensor 140, the fingerprint images including the fingerprint image showing the fingerprint of the finger that is in contact with the power button 3a and the fingerprint image showing the fingerprint of the finger that is in contact with the operation button 3b. For convenience, one of the fingerprint images showing the fingerprints detected by the fingerprint sensor 140, that is, the fingerprint image showing the fingerprint of the finger being in contact with the power button 3a is hereinafter referred to as a “right-side fingerprint image”. The other one of the fingerprint images showing the fingerprints detected by the fingerprint sensor 140, that is, the fingerprint image showing the fingerprint of the finger being in contact with the operation button 3b is hereinafter referred to as a “left-side fingerprint image”.

In the case where the controller 100 is configured to determine how the user holds the electronic apparatus 1 based on the right-side fingerprint image and the left-side fingerprint image, the storage 103 stores, for example, the reference feature point of the right-hand thumb, the reference feature point of the right-hand index finger, the reference feature point of the left-hand thumb, and the reference feature point of the left-hand index finger. The controller 100 determines how the user holds the electronic apparatus 1 based on the feature point (hereinafter referred to as a “right-side extracted feature point”) extracted from the right-side fingerprint image and the feature point (hereinafter referred to as a “left-side extracted feature point”) extracted from the left-side fingerprint image. Specifically, if the right-side extracted feature point resembles the reference feature point of the right-hand thumb stored in the storage 103 and the left-side extracted feature point resembles the reference feature point of the right-hand index finger stored in the storage 103, the controller 100 determines that the user holds the electronic apparatus 1 in the right hand facing the rear surface 1b side of the electronic apparatus 1. If the right-side extracted feature point resembles the reference feature point of the left-hand index finger stored in the storage 103 and the left-side extracted feature point resembles the reference feature point of the left-hand thumb stored in the storage 103, the controller 100 determines that the user holds the electronic apparatus 1 in the left hand facing the rear surface 1b side of the electronic apparatus 1. If the right-side extracted feature point resembles the reference feature point of the right-hand index finger stored in the storage 103 and the left-side extracted feature point resembles the reference feature point of the right-hand thumb stored in the storage 103, the controller 100 determines that the user holds the electronic apparatus 1 in the right hand facing the front surface 1a side of the electronic apparatus 1. If the right-side extracted feature point resembles the reference feature point of the left-hand thumb stored in the storage 103 and the left-side extracted feature point resembles the reference feature point of the left-hand index finger stored in the storage 103, the controller 100 determines that the user holds the electronic apparatus 1 in the left hand facing the front surface 1a side of the electronic apparatus 1.

In the case where the fingerprint sensor 140 detects the fingerprint of the finger being in contact with the power button 3a and the fingerprint of the finger being in contact with the operation button 3b, the controller 100 can more precisely determine how the user holds the electronic apparatus 1.

Similarly to the above, in the above-mentioned first modification, the controller 100 can determine how the user holds the electronic apparatus 1 based on the fingerprint detection result obtained by the fingerprint sensor 140. In addition, similarly to the above, the fingerprint sensor 140 may be configured to detect the fingerprint of the finger being in contact with the power button 3a and the fingerprint of the finger being in contact with the volume down button 3fd, and the controller 100 may determine how the user holds the electronic apparatus 1 based on the fingerprints detected by the fingerprint sensor 140 including the fingerprint of the finger being in contact with the power button 3a and the fingerprint of the finger being in contact with the volume down button 3fd.

In the case where the controller 100 is configured to determine how the user holds the electronic apparatus 1, the controller 100 may decide which function is to be assigned to the operation button 3b depending on how the user holds the apparatus. For example, the controller 100 may decide which application is to be assigned to the operation button 3b depending on how the user holds the electronic apparatus 1. Assume that the controller 100 is configured to determine in which hand, right or left, the user holds the electronic apparatus 1. If the controller 100 determines that the user holds the electronic apparatus 1 in the right hand, the controller 100 assigns, for example, the browser to the operation button 3b. if the controller 100 determines that the user holds the electronic apparatus 1 in the left hand, the controller 100 assigns, for example, the e-mail application to the operation button 3b. Thus, the application to be executed by the electronic apparatus 1 in response to an operation performed on the operation button 3b can vary depending on in which hand the user holds the electronic apparatus 1. With reference to the flowchart in FIG. 7 mentioned above, the controller 100 determines how the user holds the electronic apparatus 1 in, for example, Steps s14 and s8, and decides which function is to be assigned to the operation button 3b in accordance with the determined way of holding the apparatus.

Assume that the controller 100 is configured to determine which one of the rear surface 1b side and the front surface 1a side of the electronic apparatus 1 faces one hand in which the user holds the electronic apparatus 1. If the controller 100 determines that the user holds the electronic apparatus 1 in one hand facing the rear surface 1b side of the apparatus, the controller 100 assigns, for example, the camera application to the operation button 3b. If the controller 100 determines that the user holds the electronic apparatus 1 in one hand facing the front surface 1a side of the apparatus, the controller 100 assigns, for example, the music playback control application to the operation button 3b. Thus, the application to be executed by the electronic apparatus 1 in response to an operation performed on the operation button 3b can vary depending on which one of the rear surface 1b side and the front surface 1a side of the electronic apparatus 1 faces one hand in which the user holds the apparatus.

Assume that the controller 100 is configured to determine in which hand the user holds the electronic apparatus 1, the hand being the right hand facing the rear surface 1b side of the apparatus, the right hand facing the front surface 1a side of the apparatus, the left hand facing the rear surface 1b side of the apparatus, or the left hand facing the front surface 1a side of the apparatus. If the controller 100 determines that the user holds the electronic apparatus 1 in the right hand facing the rear surface 1b side of the apparatus, the controller 100 assigns, for example, the camera application to the operation button 3b. If the controller 100 determines that the user holds the electronic apparatus 1 in the right hand facing the front surface 1a side of the apparatus, the controller 100 assigns, for example, the music playback control application to the operation button 3b. If the controller 100 determines that the user holds the electronic apparatus 1 in the left hand facing the rear surface 1b side of the apparatus, the controller 100 assigns, for example, the browser to the operation button 3b. If the controller 10 determines that the user holds the electronic apparatus 1 in the left hand facing the front surface 1a side of the apparatus, the controller 100 assigns, for example, the e-mail application to the operation button 3b. Thus, the application to be executed by the electronic apparatus 1 in response to an operation performed on the operation button 3b can vary depending on in which hand the user holds the electronic apparatus 1 and whether the rear surface 1b side of the electronic apparatus 1 faces the hand in which the user holds the apparatus.

In the case where the controller 100 according to the first modification is configured to determine how the user holds the electronic apparatus 1, the controller 100 may decide which function is to be assigned to the down button 3fd depending on how the user holds the electronic apparatus 1. If the controller 100, which is configured to determine in which hand, right or left, the user holds the electronic apparatus 1, determines that the user holds the electronic apparatus 1 in the right hand, the controller 100 assigns the original manner mode setting to the down button 3fd. If the controller 100 determines that the user holds the electronic apparatus 1 in the left hand, the controller 100 assigns, to the down button 3fd, the setting of the operation mode to a manner mode preset in the electronic apparatus 1. Thus, the type of manner mode to be set to the electronic apparatus 1 in response to a long press operation performed on the down button 3fd can vary depending on in which hand the user holds the electronic apparatus 1.

<Fourth Modification: User Authentication Executed in Other Situations>

In one example above, user authentication is executed when the lock mode is released in one example above, user authentication may be executed in other situations. The following will describe various examples of situations in which user authentication is to be executed.

<Operation on Application Icon>

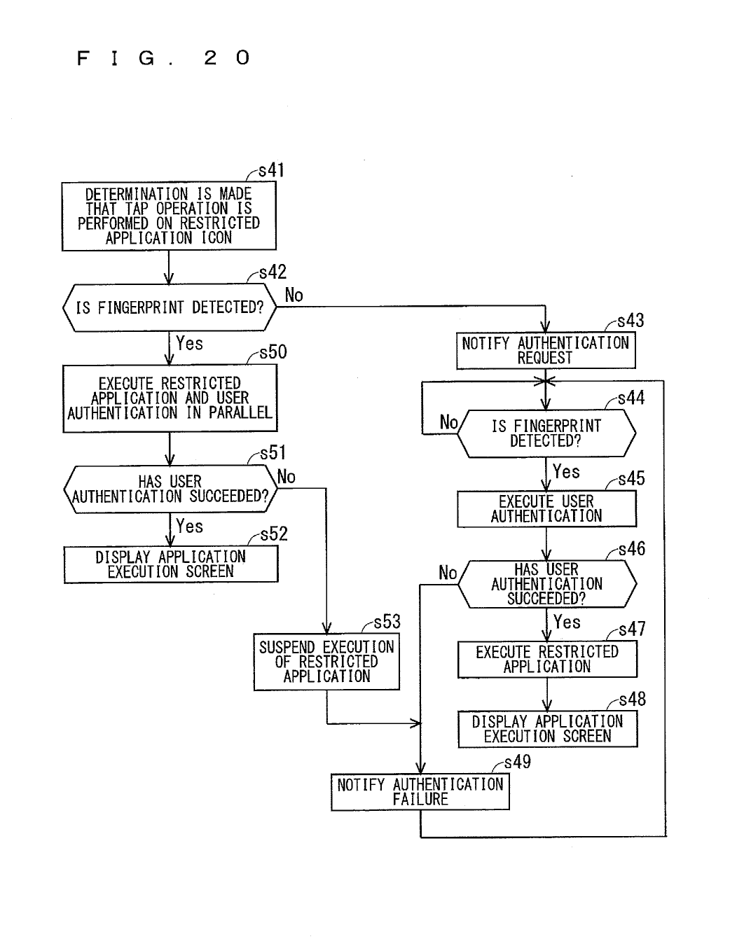

FIG. 20 is an illustration of a flowchart showing the operation of the electronic apparatus 1 according to one modification. In one modification, the user can restrict the execution of a predetermined application in the electronic apparatus 1 by performing an operation on the display area 20. Under a restriction of execution of the application in the electronic apparatus 1, the application execution screen corresponding to the application is displayed in the display area 20 only if the user authentication succeeds. The application being the target of the application execution restriction is hereinafter referred to as a “restricted application”. The application icon corresponding to the restricted application is hereinafter referred to as a “restricted application icon”.

As illustrated in FIG. 20, with the electronic apparatus 1 being displayed on the above-mentioned home screen 300, if the controller 100 determines, in Step s41, that a tap operation is performed on the restricted application icon 305, the controller 100 determines, in Step s42, whether a finger print is detected by the fingerprint sensor 140. The controller 100 can make such a determination as long as the power button 3a is in contact with a finger of the user, regardless of whether the power button 3a is pressed with the finger of the user.

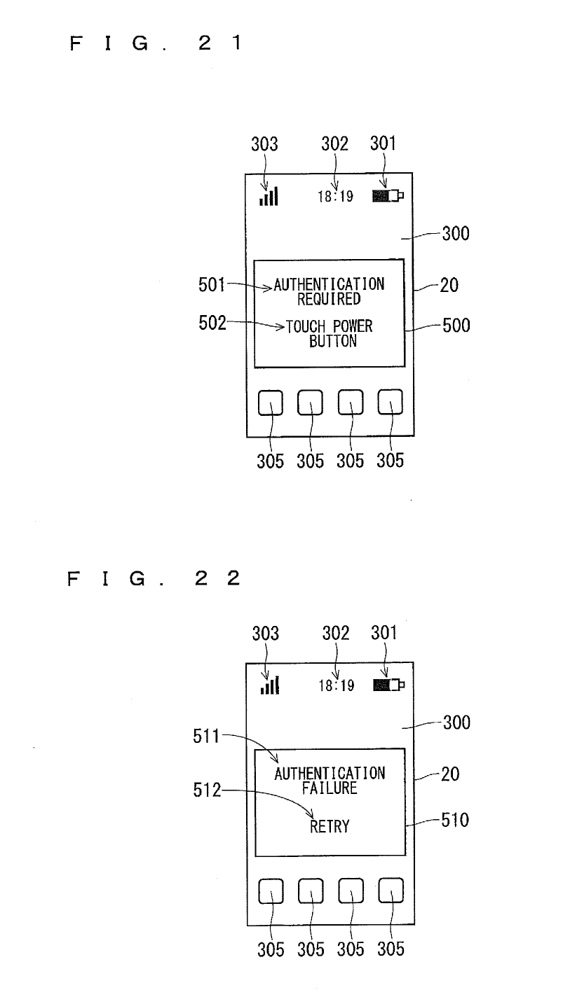

If the controller 100 determines, in Step s42, that no fingerprint is detected by the fingerprint sensor 140, in Step s43, the controller 100 causes the display 220 to display the home screen 300 on which a notification screen 500 for notifying a user authentication request is superimposed. FIG. 21 is an illustration of an example of the notification screen 500. The notification screen 500 includes notification information 501 and instruction information 502. The notification information 501 is the information for notifying user authentication is required in the execution of the restricted application corresponding to the restricted application icon 305 being the target of the tap operation. The instruction information 502 is the information for instructing the user to touch the power button 3a to undergo user authentication.

When the notification screen 500 is displayed, in Step s44, the controller 100 enters the fingerprint detection wait state and determines whether a fingerprint is detected by the fingerprint sensor 140. If the controller 100 determines that a fingerprint is detected by the fingerprint sensor 140, in Step s45, the controller 100 executes user authentication, similarly to the above. The controller 100 repeatedly executes Step s44 until it determines that a fingerprint is detected by the fingerprint sensor 140.

Upon completion of the user authentication in Step s45, in Step s46, the controller 100 determines whether the user authentication has succeeded. If the controller 100 determines that the user authentication has succeeded, in Step s47, the controller 100 executes the restricted application corresponding to the restricted application icon 305 being the target of the operation. Then, the controller 100 causes the display 220 to display, in place of the home screen 300 including the notification screen 500 superimposed thereon, the application execution screen corresponding to the restricted application that is running.

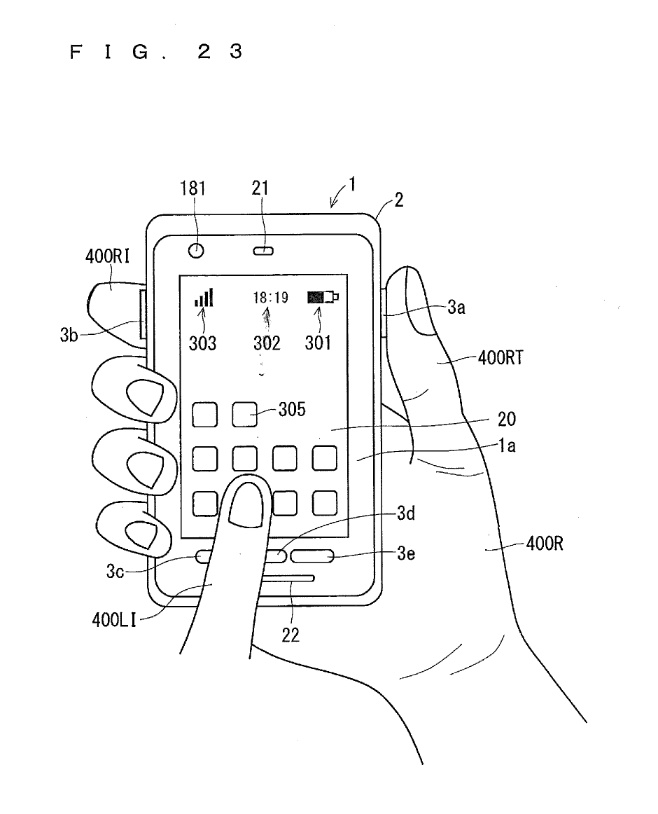

If the controller 100 determines, in step s46, that the user authentication has failed, in Step s49, the controller 100 causes the display 220 to display the home screen 300 on which a notification screen 510 for notifying the user authentication failure is superimposed. FIG. 22 is an illustration of an example of the notification screen 510. The notification screen 510 includes authentication failure notification information 511 for notifying the user authentication failure and information 512 for instructing the user to touch the power button 3a again.

Subsequent to Step s49, the controller 100 enters the fingerprint detection wait state again and executes Step s44. From that time forward, the electronic apparatus 1 operates similarly to the above.

When an operation is performed on the display area 20, the controller 100 is released from the fingerprint detection wait state. Then, the home screen 300 illustrated in FIG. 5 is displayed in the display area 20.

If the controller 100 determines, in Step s42, that a fingerprint is detected by the fingerprint sensor 140, in Step s50, the controller 100 starts executing user authentication and the restricted application corresponding to the restricted application icon 305 being the target of the tap operation. The controller 100 executes user authentication and the restricted application in parallel. That is to say, the controller 100 executes, in parallel, user authentication and the function assigned to the restricted application icon 305 being the target of the tap operation.

Upon completion of the user authentication in Step s50, in Step s51, the controller 100 determines whether the user authentication has succeeded. If the controller 100 determines that the user authentication has succeeded, in Step s52, the controller 100 causes the display 220 to display the application execution screen corresponding to the restricted application that is running. Consequently, the display area 20 in the state of displaying the home screen 300 illustrated in FIG. 5 shifts to the state of displaying the application execution screen without going into the state of displaying the notification screen 500 illustrated in FIG. 21.

If the controller 100 determines, in Step s51, that the user authentication has failed, in Step s53, the controller 100 suspends the execution of the restricted application corresponding to the restricted application icon 305 being the target of the tap operation, and executes Step s49 above. Consequently, as illustrated in FIG. 22, the home screen 300 including the notification screen 510 superimposed thereon is displayed in the display area 20.

Subsequent to Step s49, the controller 100 enters the fingerprint detection wait state and executes Step s44. From that time forward, the electronic apparatus 1 operates similarly to the above.

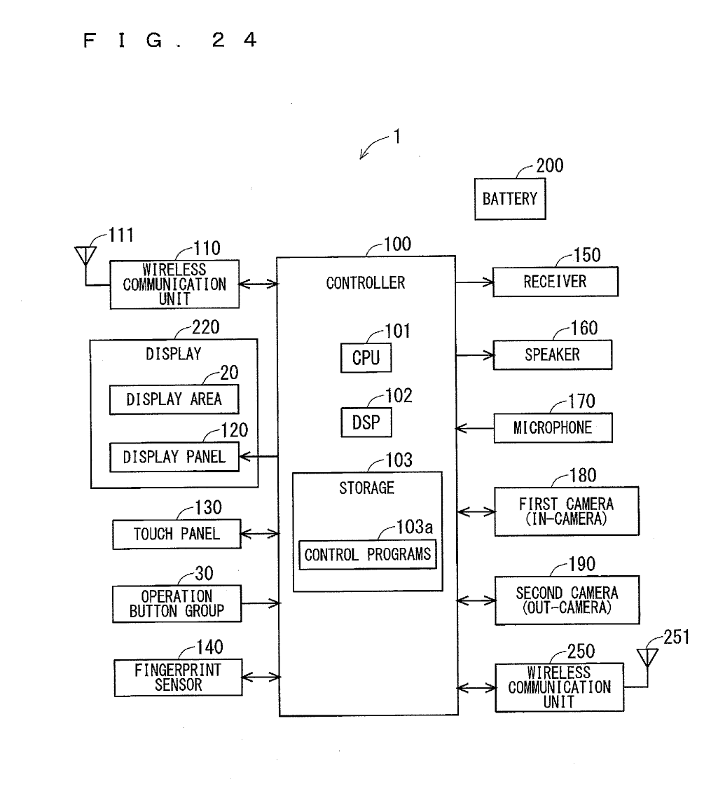

As described above, in one modification, with a fingerprint being detected by the fingerprint sensor 140, when an operation is performed on the restricted application icon 305 being a software button, the controller 100 executes user authentication and the restricted application corresponding to the restricted application icon 305 being the target of the operation. Thus, when the user whose finger is in contact with the power button 3a performs an operation on the restricted application icon 305, the controller 100 executes user authentication and the restricted application corresponding to the restricted application icon 305. This improves the operability of the electronic apparatus 1, similarly to the above. As illustrated in FIG. 23, the user can cause the electronic apparatus 1 to execute user authentication and the restricted application by, for example, performing a tap operation on the restricted application icon 305 with the left-hand index finger 400LI while holding the electronic apparatus 1 in the right hand 400R facing the rear surface 1b side of the apparatus in such a manner that the right-hand thumb 400RT is in contact with the power button 3a.

<Electronic Payment>

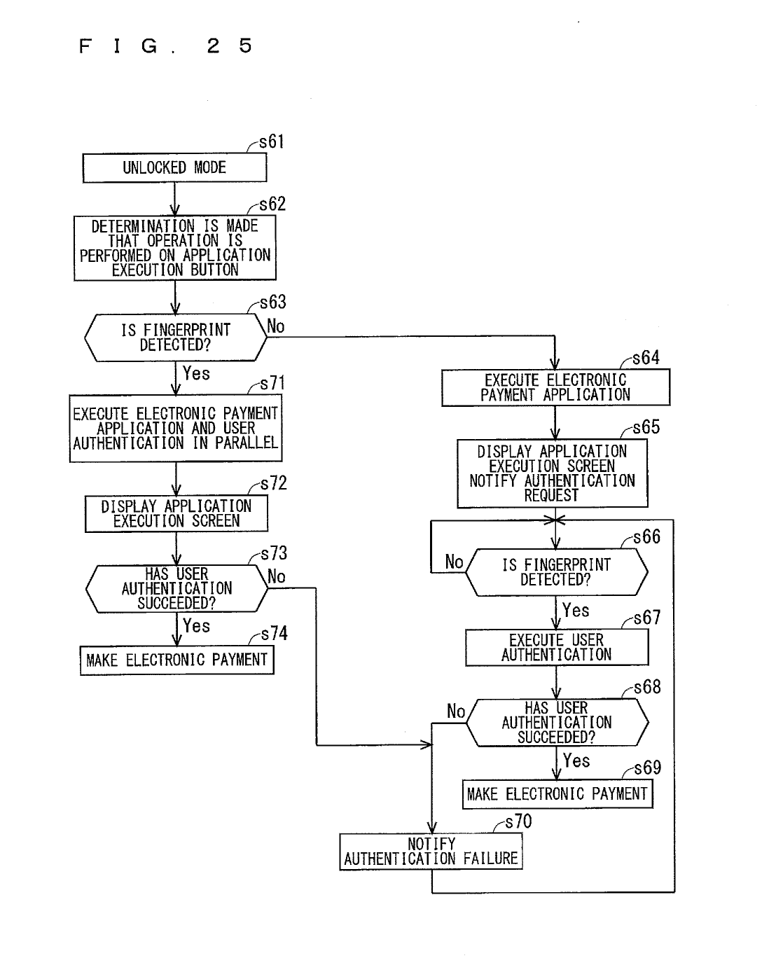

FIG. 24 is an illustration of the configuration of the electronic apparatus 1 according to one modification. FIG. 25 is an illustration of a flowchart showing the operation of the electronic apparatus 1 according to one modification.

The electronic apparatus 1 according to one modification includes a wireless communication unit 250 equipped with an antenna 251. The wireless communication unit 250 performs short-range wireless communication such as NFC (Near Field Communication) through the antenna 251. The communication area for the wireless communication unit 250 is smaller than the communication area for the wireless communication unit 110. The electronic apparatus 1 assumes the function of making electronic payments using the wireless communication unit 250. The wireless communication unit 250 is accommodated in the apparatus case 2 of the electronic apparatus 1 so as to be adjacent to the rear surface 1b. The application execution button 3b is assigned an electronic payment application for making electronic payments. The electronic payment application is stored in the storage 103.

In one modification, the user can perform an operation on the application execution button 3b while holding the electronic apparatus 1 in the unlocked mode in a manner to bring the rear surface 1b close to (while holding the electronic apparatus 1 over) an apparatus (hereinafter, referred to as a “target apparatus”) installed in, for example, a shop and configured to communicate with the electronic apparatus 1 to make electronic payments with the electronic apparatus 1, thereby causing can cause the electronic apparatus 1 to make an electronic payment with the target apparatus. To cause the electronic apparatus 1 to make an electronic payment, as illustrated in, for example, FIG. 19 mentioned above, the user brings the rear surface 1b of the electronic apparatus 1 close to the target apparatus while holding the electronic apparatus 1 in one hand facing the front surface 1a side of the electronic apparatus 1. The electronic apparatus 1 makes an electronic payment if user authentication succeeds. In other words, the electronic apparatus 1 executes user authentication for the electronic payment.

As illustrated in FIG. 25, assuming that the electronic apparatus 1 operates in the unlocked mode in Step s61, if the controller 100 determines, in Step s62, that an operation is performed on the application execution button 3b, in Step s63, the controller 100 determines whether a fingerprint is detected by the fingerprint sensor 140. The controller 100 can make such a determination as long as the power button 3a is in contact with a finger of the user, regardless of whether the power button 3a is pressed with the finger of the user.

If the controller 100 determines, in Step s63, that no fingerprint is detected by the fingerprint sensor 140, in Step s64, the controller 100 executes the electronic payment application. Then, in Step s65, the controller 100 causes the display 220 to display the application execution screen corresponding to the electronic payment application. A notification screen for notifying a user authentication request is superimposed on the application execution screen. As in FIG. 21 mentioned above, the notification screen includes, for example, notification information for notifying user authentication is required in making an electronic payment and instruction information for instructing the user to touch the power button 3a in order to undergo user authentication.

Subsequent to Step s65, the controller 100 enters the fingerprint detection wait state and determines, in Step s66, whether a fingerprint is detected by the fingerprint sensor 140. If the controller 100 determines that a fingerprint is detected by the fingerprint sensor 140, in Step s67, the controller 100 executes user authentication. The controller 100 repeatedly executes Step s66 until it determines that a fingerprint is detected by the fingerprint sensor 140.

Upon completion of the user authentication in Step s67, in Step s68, the controller 100 determines whether the user authentication has succeeded. If the controller 100 determines that the user authentication has succeeded, in Step s69, the controller 100 causes the wireless communication unit 250 to wirelessly communicate with the target apparatus and to make an electronic payment with the target apparatus.

If the controller 100 determines that the user authentication has failed, in Step s70, the controller 100 causes the display 220 to display the application execution screen on which the notification screen 510 (see FIG. 22) for notifying the user authentication failure is superimposed.

Subsequent to Step S70, the controller 100 enters the fingerprint detection wait state again and executes Step s66. From that time forward, the electronic apparatus 1 operates similarly to the above.

If the controller 100 determines, in Step s63, that a fingerprint is detected by the fingerprint sensor 140, in Step s71, the controller 100 starts executing the electronic payment application and user authentication, thus executing the electronic payment application and user authentication in parallel. Then, in Step s72, the controller 100 causes the display 220 to display the application execution screen corresponding to the electronic payment application.

Upon completion of the user authentication in Step s71, in Step s73, the controller 100 determines whether the user authentication has succeeded. If the controller 100 determines that the user authentication has succeeded, in Step s74, the controller 100 causes the wireless communication unit 250 to wirelessly communicate with the target apparatus and to make an electronic payment with the target apparatus.

If the controller 100 determines that the user authentication has failed, the controller 100 executes Step s70, thereby causing the display 220 to display the application execution screen including the notification screen 510 superimposed thereon. Subsequent to Step s70, the controller 100 enters the fingerprint detection wait state and executes Step s66. From that time forward, the electronic apparatus 1 operates similarly to the above.

As described above, in one modification, with a fingerprint being detected by the fingerprint sensor 140, when an operation is performed on the application execution button 3b that is assigned the electronic payment application, the controller 100 executes user authentication and the electronic payment application. Thus, when the user whose finger is in contact with the power button 3a performs an operation on the application execution button 3b, the controller 100 executes user authentication and the electronic payment application. This improves the operability of the electronic apparatus 1, similarly to the above. For example, as illustrated in FIG. 19, the user can cause the electronic apparatus 1 to execute user authentication and the electronic payment application by performing an operation on the operation button 3b with the right-hand thumb 400RT while holding the electronic apparatus 1 in the unlocked mode in the right hand 400R facing the front surface 1a side of the apparatus in a manner to bring the right-hand index finger 400RI into contact with the power button 3a.

As described above, in one modification, the wireless communication unit 250 for use in electronic payments is accommodated in the apparatus case 2 so as to be adjacent to the rear surface 1b. Thus, as illustrated in FIG. 19, the user is more likely to hold the electronic apparatus 1 in one hand facing the front surface 1a side of the apparatus in a manner to easily bring the rear surface 1b close to the target apparatus. In view of such possibilities, the controller 100 may assign the electronic payment application to the operation button 3b on the basis of its determination that the user holds the electronic apparatus 1 in one hand facing the front surface 1a side of electronic apparatus, and may assign an application other than the electronic payment application to the operation button 3b on the basis of its determination that the user holds the electronic apparatus 1 in one hand facing the rear surface 1b side of the apparatus. In this configuration, when the user holds the electronic apparatus 1 in one hand facing the front surface 1a side of the apparatus, the electronic payment application automatically replaces the application originally assigned to the operation button 3b. This improves the operability of the electronic apparatus 1, where a plurality of applications are assigned to the operation button 3b.

<Access to Private Folder>

In the electronic apparatus 1 according to one modification, the controller 100 can save images captured by the cameras in folders. The folders in which captured images are to be stored include a private folder that is accessible to the user only if user authentication succeeds. Unlike the private folder, another folder is accessible to the user without user authentication and is referred to as a “normal folder”.

When the user performs an operation on the display area 20 to instruct the controller 100 to access the private folder during the execution of, for example, the camera application, the controller 100 causes the display 220 to superimpose, onto the application execution screen corresponding to the camera application, the notification screen 500 for notifying a user authentication request as in FIG. 21 mentioned above. Then, the controller 100 enters the fingerprint detection wait state. When a fingerprint is detected by the fingerprint sensor 140, the controller 100 executes user authentication. If the user authentication succeeds, the controller 100 accesses the private folder in accordance with the instruction from the user. In response to an instruction from the user to save an image in the private folder, the controller 100 saves the image in the private folder. In response to an instruction from the user to display an image stored in the private folder, the controller 100 causes the display 220 to display the image stored in the private folder. If the user authentication fails, meanwhile, the controller 100 causes the display 220 to superimpose, onto the application execution screen corresponding to the camera application, the notification screen 510 for notifying the user authentication failure as in FIG. 22 mentioned above.

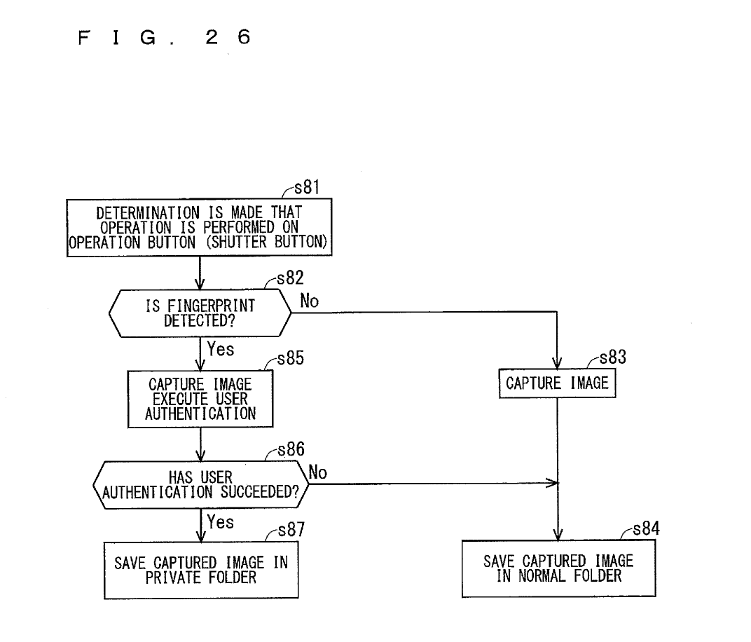

In one modification, with the power button 3a being in contact with a finger, when the camera captures an image, the controller 100 executes user authentication to access the private folder. If the user authentication succeeds, the controller 100 saves the image captured by the camera in the private folder. If the user authentication fails or if the camera captures an image in the absence of a finger being in contact with the power button 3a, the controller 100 saves the image capture by the camera in the normal folder. In one modification, the operation button 3b functions as a shutter button during the execution of the camera application. FIG. 26 is an illustration of the operation of the electronic apparatus 1 according to one modification.

As illustrated in FIG. 26, if the controller 100 determines, in Step s81, that an operation is performed on the operation button 3b functioning as the shutter button, in Step s82, the controller 100 determines whether a fingerprint is detected by the fingerprint sensor 140. The controller 100 can make such a determination as long as the power button 3a is in contact with a finger of the user, regardless of whether the power button 3a is pressed with the finger of the user.

If the controller 100 determines, in Step s82, that no fingerprint is detected by the fingerprint sensor 140, in Step s83, the controller 100 causes a camera (the in-camera 180 or the out-camera 190) to capture an image. Then, in Step s84, the controller 100 saves the image captured by the camera in the normal folder.

If the controller 100 determines, in Step s82, that a fingerprint is detected by the fingerprint sensor 140, in Step s85, the controller 100 causes the camera to capture an image and executes user authentication. Upon completion of the user authentication in Step s85, the controller 100 determines, in Step s86, whether the user authentication has succeeded. If the controller 100 determines that the user authentication has succeeded, in Step s87, the controller 100 saves the image captured by the camera in the private folder. If the controller 100 determines that the user authentication has failed, the controller 100 executes Step s84 to save the image captured by the camera in the normal folder.

As described above, in one modification, with a fingerprint being detected by the fingerprint sensor 140, when an operation is performed on the shutter button, the controller 100 causes the camera to capture an image and executes user authentication. Thus, when the user whose finger is in contact with the power button 3a performs an operation on the shutter button (the operation button 3b), the controller 100 executes user authentication and causes the camera to capture an image. This improves the operability of the electronic apparatus 1.

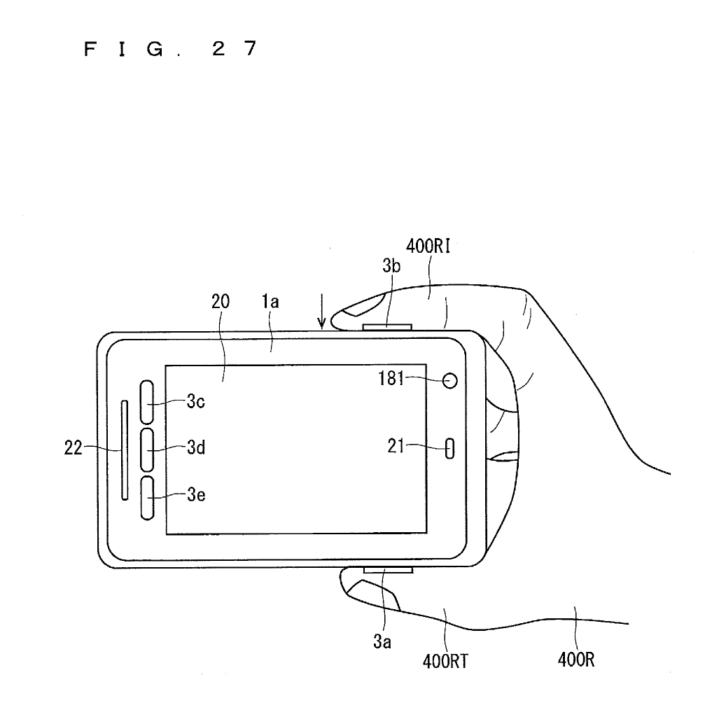

The user causes the out-camera 190 to capture an image in the following manner. For example, as illustrated in FIG. 27, while the user holds the electronic apparatus 1 executing the camera application in the right hand 400R in such a manner that the right-hand thumb 400RT is in contact with the power button 3a and that the right-hand index finger 400RI is in contact with the operation button 3b, the user performs an operation on the operation button 3b with the right-hand index finger 400RI. In response to this operation, the electronic apparatus 1 executes user authentication and causes the camera to capture an image.

When the user whose finger is in contact with the power button 3a performs a tap operation on the application icon 305 corresponding to the camera application, the controller 100 may execute, in parallel, the camera application and user authentication for access to the private folder. Specifically, when the controller 100 determines that a tap operation is performed on the application icon corresponding to the camera application, the controller 100 determines whether a fingerprint is detected by the fingerprint sensor 140. If the controller 100 determines that no fingerprint is detected by the fingerprint sensor 140, the controller 100 executes the camera application. If the controller 100 determines that a fingerprint is detected by the fingerprint sensor 140, the controller 100 executes the camera application and user authentication in parallel. If the user authentication succeeds, the controller 100 makes the private folder accessible to the user during the execution of the camera application. In other words, when the user inputs an instruction to access the private folder during the execution of the camera application, the controller 100 accesses the private folder in accordance with the access instruction without executing user authentication. If the user authentication fails, the controller 100 executes the camera application. In this case, the controller 100 does not make the private folder accessible to the user during the execution of the camera application. Thus, when the user who has undergone a user authentication failure inputs an instruction to access the private folder during the execution of the camera application, the controller 100 causes the display 220 to superimpose, onto the application execution screen corresponding to the camera application, the notification screen 500 for notifying a user authentication request as described above. Then, the controller 100 enters the fingerprint detection wait state. When a fingerprint is detected by the fingerprint sensor 140, the controller 100 executes user authentication. Form that time forward, the controller 100 operates similarly to the above.

As described above, when the user whose finger is in contact with the power button 3a performs a tap operation on the application icon 305 corresponding to the camera application, the controller 100 executes the camera application and user authentication for access to the private folder. This improves the operability of the electronic apparatus 1.

The controller 100 may execute the camera application in response to a predetermined operation performed by the user on the display area 20 of the electronic apparatus 1 in the lock mode. While the electronic apparatus 1 in the lock mode executes the camera application, a preview screen (also called a “through screen”) may be displayed in the display area 20. In this case, if user authentication succeeds, the controller 100 may cause the display 220 to display an image in the private folder.

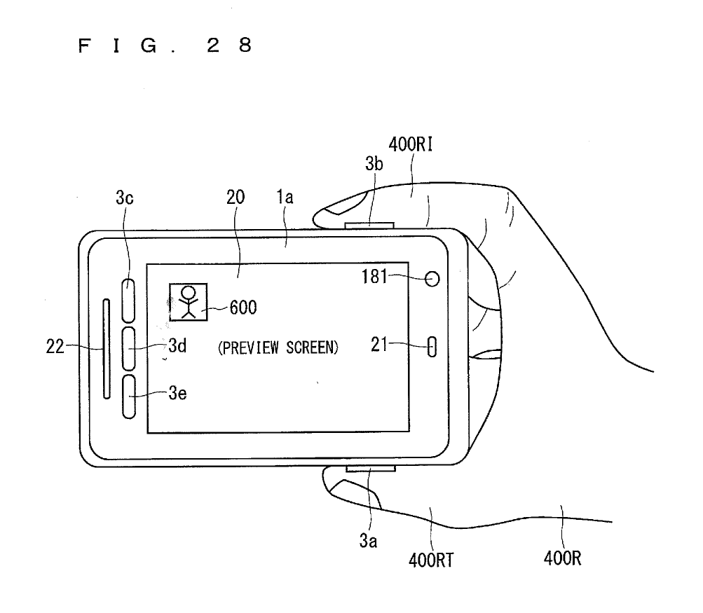

FIG. 28 is an illustration of an example of the state in which an image in the private folder is displayed in the display area 20 in which the preview screen is displayed. While the preview screen is displayed on the electronic apparatus 1 in the lock mode, the user can cause the electronic apparatus 1 to execute user authentication by touching the power button 3a with a finger. When a fingerprint is detected by the fingerprint sensor 140 of the electronic apparatus 1 in the lock mode, on which the preview screen is displayed, the controller 100 executes user authentication. If the user authentication succeeds, the controller 100 causes an image 600 in the private folder to be displayed. For example, as illustrated in FIG. 28, the controller 100 causes the recently captured image 600 in the private folder to be superimposed onto the preview screen. If the user authentication executed by the controller 100 fails, the private folder remains inaccessible to the user and no image in the private folder is displayed in the display area 20 accordingly.

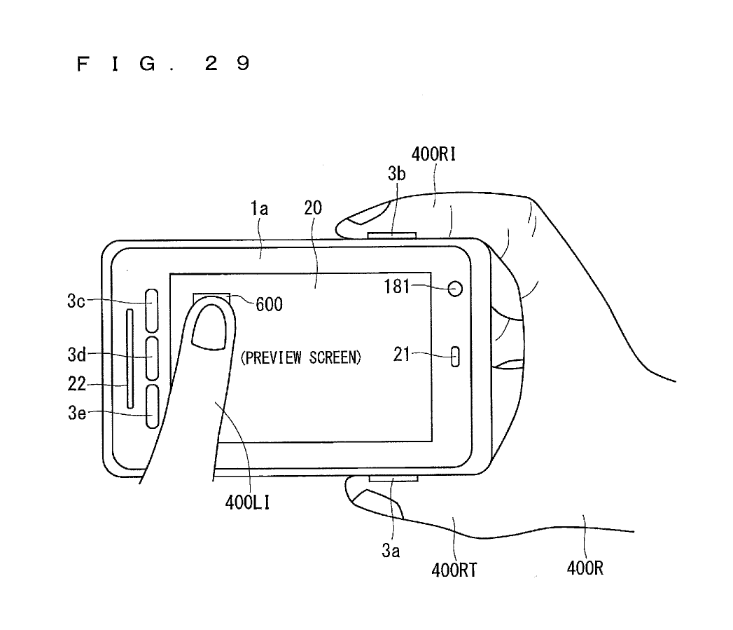

When a predetermined operation (e.g., a tap operation) is performed on the image 600, the controller 100 causes the display 220 to enlarge and display the image 600 in place of the preview screen. FIG. 29 is an illustration of the state in which a tap operation is performed on the image 600 with a finger.

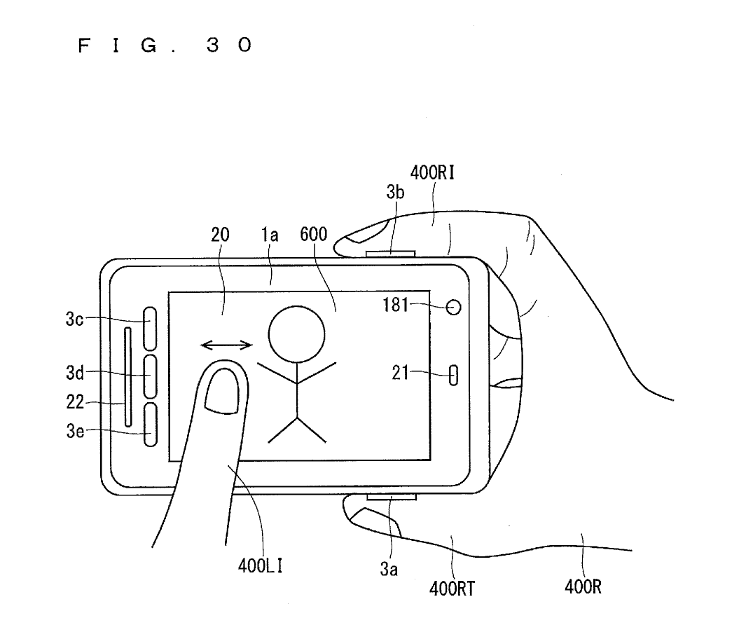

With the image 600 being enlarged and displayed on the electronic apparatus 1 in the lock mode, when the user performs, for example, a slide operation on the display area 20, the controller 100 causes the display 220 to replace the image 600 with another image in the private folder. FIG. 30 is an illustration of the state in which the user performs a slide operation on the display area 20 with a finger.

<Access to Specific Webpage>

When the electronic apparatus 1 tries to access a specific webpage, a user authentication request may come in. For example, some of the webpages in SNS (Social Networking Service) are exclusively accessible to certain members. In some cases, the electronic apparatus 1 trying to access such a webpage receives a user authentication request. The webpages that the necessitate user authentication before access can be obtained are hereinafter simply referred to as “specific webpages”.

In one modification, when the user performs an operation on the display area 20 to instruct the controller 100 to access the specific webpage, the controller 100 causes the display 220 to display the notification screen 500 for notifying a user authentication request as in FIG. 21 mentioned above. Then, the controller 100 enters the fingerprint detection wait state. When a fingerprint is detected by the fingerprint sensor 140, the controller 100 executes user authentication. If the user authentication succeeds, the controller 100 accesses the specific webpage in accordance with the instruction from the user. For example, the controller 100 causes the display 220 to display the specific webpage or uploads an image to the specific webpage using the wireless communication unit 110. If the user authentication fails, the controller 100 causes the display 220 to display the notification screen 510 for notifying the user authentication failure as in FIG. 22 mentioned above.

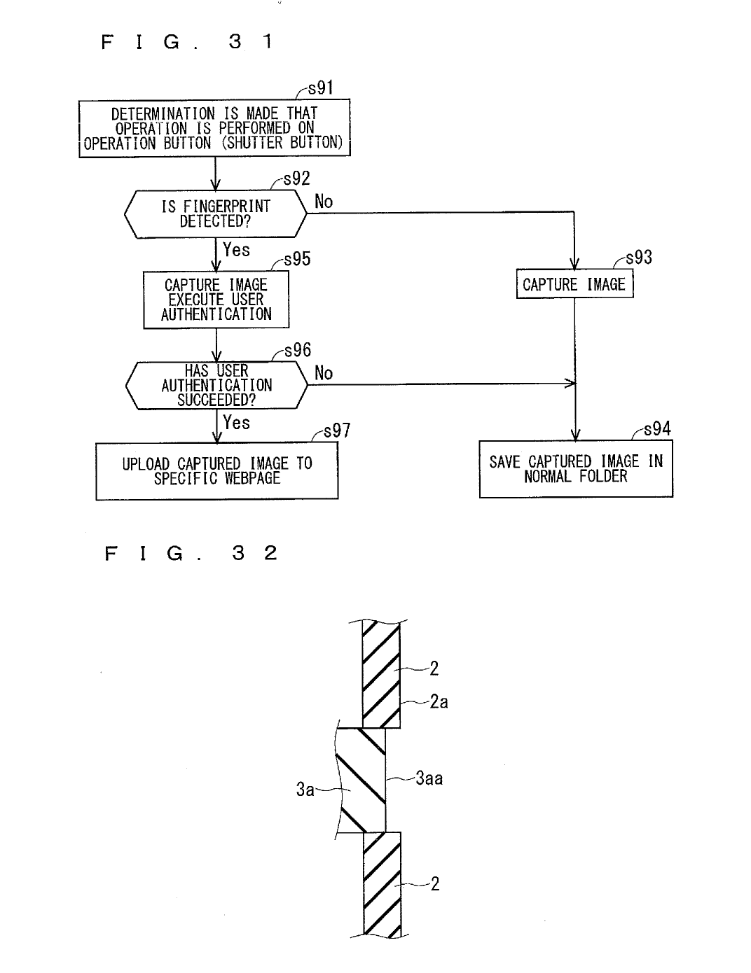

In one embodiment, with the power button 3a being in contact with a finger, when the camera captures an image, the controller 100 executes user authentication for access to the specific webpage. If the user authentication succeeds, the controller 100 uploads the image captured by the camera to the specific webpage. If the user authentication fails or if the camera captures an image in the absence of a finger that is in contact with the power button 3a, the controller 100 saves the image captured by the camera in the normal folder. In one modification, the operation button 3b functions as the shutter button during the execution of the camera application. FIG. 31 is an illustration of the operation of the electronic apparatus 1 according to one modification.

As illustrated in FIG. 31, if the controller 100 determines, in Step s91, that an operation is performed on the operation button 3b functioning as the shutter button, in Step s92, the controller 100 determines whether a fingerprint is detected by the fingerprint sensor 140. The controller 100 can make such a determination as long as the power button 3a is in contact with a finger of the user, regardless of whether the power button 3a is pressed with the finger of the user.

If the controller 100 determines, in Step s92, that no fingerprint is detected by the fingerprint sensor 140, in Step s93, the controller 100 causes the camera (the in-camera 180 or the out-camera 190) to capture an image. Then, in Step s94, the controller 100 saves the image captured by the camera in the normal folder.

If the controller 100 determines, in Step s92, that a fingerprint is detected by the fingerprint sensor 140, in Step s95, the controller 100 causes the camera to capture an image and executes user authentication. Upon completion of the user authentication in Step s95, in Step s96, the controller 100 determines whether the user authentication has succeeded. If the controller 100 determines that the user authentication has succeeded, in Step s97, the controller 100 accesses the specific webpage using the wireless communication unit 110 and uploads the image captured by the camera to the specific webpage. If the controller 100 determines that the user authentication has failed, the controller 100 executes Step s94 to save the image captured by the camera in the normal folder.

As described above, in one modification, with a fingerprint being detected by the fingerprint sensor 140, when an operation is performed on the shutter button, the controller 100 causes the camera to capture an image and executes user authentication. Thus, when the user whose finger is in contact with the power button 3a performs an operation on the shutter button (the operation button 3b), the controller 100 executes user authentication and causes the camera to capture an image. This improves the operability of the electronic apparatus 1.

When the authorized user whose finger is in contact with the power button 3a performs an operation on the shutter button, the camera captures an image, and the image captures by the camera is uploaded to the specific webpage in, for example, SNS.

In some cases, the storage 103 stores a predetermined website application for obtaining access to a predetermined website in, for example, SNS. In this case, when the user whose finger is in contact with the power button 3a performs a tap operation on the application icon 305 corresponding to the predetermined website application, the controller 100 may execute, in parallel, the predetermined website application and user authentication for access to the specific webpage (the webpage that necessitates user authentication before access can be obtained) included in the predetermined website. Specifically, if the controller 100 determines that a tap operation is performed on the application icon corresponding to the predetermined website application, the controller 100 determines whether a fingerprint is detected by the fingerprint sensor 140. If the controller 100 determines that no fingerprint is detected by the fingerprint sensor 140, the controller 100 executes the predetermined website application. If the controller 100 determines that a fingerprint is detected by the fingerprint sensor 140, the controller 100 executes the predetermined website application and user authentication in parallel. If the user authentication succeeds, the controller 100 makes the specific webpage included in the predetermined website accessible to the user during the execution of the predetermined website application. In other words, when the user inputs an instruction to access the specific webpage included in the predetermined website during the execution of the predetermined website application, the controller 100 accesses the specific webpage in accordance with the access instruction without executing user authentication. If the user authentication fails, the controller 100 executes the predetermined website application. In this case, the controller 100 does not make the specific webpage included in the predetermined website accessible to the user during the execution of the predetermined website application. Thus, when the user who has undergone a user authentication failure inputs an instruction to access the specific webpage included in the predetermined website during the execution of the predetermined website application, the controller 100 causes the display 220 to display the notification screen 500 for notifying a user authentication request as described above. Then, the controller 100 enters the fingerprint detection wait state. When a fingerprint is detected by the fingerprint sensor 140, the controller 100 executes user authentication. From that time forward, the controller 100 operates similarly to the above.

As described above, when the user whose finger is in contact with the power button 3a performs a tap operation on the application icon 305 corresponding to the predetermined website application, the controller 100 executes the predetermined website application and user authentication for access to the specific webpage. This improves the operability of the electronic apparatus 1.

In some embodiments, the fingerprint sensor 140 can detect a finger that is in contact with a hardware button (e.g., the power button or the home button) located in the rear surface 1b of the electronic apparatus 1. In this case, the user whose finger is in contact with the hardware button located in the rear surface 1b of the electronic apparatus 1 can perform an operation on the operation button 3b to cause the electronic apparatus 1 to execute user authentication and the function assigned to the operation button 3b. In some embodiments, the fingerprint sensor 140 can detect a finger that is in contact with a hardware button located in the upper side surface 1e of the electronic apparatus 1 or detects a finger that is in contact with the hardware button located in the lower side surface if of the electronic apparatus 1.

In some embodiments, the fingerprint sensor 140 is configured to detect a finger that is in contact with a software button displayed in the display area 20. For example, the fingerprint sensor 140 is configured to detect a finger that is in contact with a software button, which may be an icon, the power button, or the home button. In this case, the fingerprint sensor 140 includes, for example, the touch panel 130.

In some embodiments, the fingerprint sensor 140 is configured to detect not only the fingerprint of a finger that is in contact with an operation button but also the fingerprint of a finger that comes close to the operation button. In this case, the fingerprint sensor 140 includes, for example, a camera whose lens is exposed at the surface of the operation button.

In some embodiments, the controller 100 can execute the function assigned to a software button displayed in the display area 20 when an operation other than a tap operation, such as a slide operation, is performed on the software button.

In some embodiments, the user may hold the electronic apparatus 1 in a manner different from the above or may operate the operation buttons 3 of the electronic apparatus 1 in a manner different from the above.

In some embodiments, the storage 103 can store reference feature points indicating the features of fingerprints of a plurality of users.

In some embodiments, at least one of the plurality of operation buttons 3 does not protrude from a surface of the apparatus case 2. For example, the exposed surface of at least one of the plurality of operation buttons 3 exposed at the apparatus case 2 is located inboard with respect to a surface of the apparatus case 2. FIG. 32 is an illustration of the state in which an exposed surface 3aa of the power button 3a exposed at the apparatus case 2 is located inboard with respect to a surface 2a (specifically, the right side surface) of the apparatus case 2. FIG. 32 is an illustration of the cross-sectional structure of the apparatus case 2 and the cross-sectional structure of the power button 3a. With reference to FIG. 32, the left side of the apparatus case 2 and the left side of the power button 3a correspond to the inner side of the electronic apparatus 1, and the right side of the apparatus case 2 and the right side of the power button 3a correspond to the outer side of the electronic apparatus 1.

In some embodiments, the electronic apparatus 1 is a device other than a mobile phone such as a smartphone. The electronic apparatus 1 is, for example, a tablet terminal, a personal computer, a camera, a wearable device (e.g., eyeglasses, a watch, or a wrist band), a healthcare product, an automobile-related product (e.g., a car navigation), or a shaver.

While the electronic apparatus 1 has been described above in detail, the above description is in all aspects illustrative and not restrictive. Also, various modifications described above are applicable in combination as long as they are consistent with each other. It is understood that numerous modifications which have not been exemplified can be devised without departing from the scope of the present disclosure.

1. An electronic apparatus comprising:
a case;
a first hardware button located in one of a right side surface and a left side surface of the case;
a fingerprint sensor configured to detect a fingerprint of a finger being in contact with the first hardware button;
an operation button; and
at least one processor configured to execute user authentication based on a fingerprint detection result obtained by the fingerprint sensor and to execute a function assigned to the operation button in response to an operation performed on the operation button, wherein
the at least one processor executes the user authentication and the function when an operation is performed on the operation button in a state in which the first hardware button is in contact with a finger.

2. The electronic apparatus according to claim 1, wherein
the first hardware button protrudes from a surface of the case to the outside.

3. The electronic apparatus according to claim 1, wherein
an exposed surface of the first hardware button exposed at the case is located inboard with respect to a surface of the case.

4. The electronic apparatus according to claim 1, wherein
the at least one processor determines how a user holds the electronic apparatus based on a fingerprint detection result obtained by the fingerprint sensor, and
the at least one processor determines a function to be assigned to the operation button depending on how the user holds the electronic apparatus.

5. The electronic apparatus according to claim 4, wherein
the at least one processor determines in which of a right hand and a left hand the user holds the electronic apparatus.

6. The electronic apparatus according to claim 4, wherein
the at least one processor determines which one of a rear surface side and a front surface side of the electronic apparatus faces one hand in which the user holds the electronic apparatus.

7. The electronic apparatus according to claim 4, wherein
the first hardware button is a power button,
the operation button is a second hardware button,
the operation button is located in the other one of the right side surface and the left side surface,
the fingerprint sensor detects a fingerprint of a finger being in contact with the operation button, and
the at least one processor determines how the user holds the electronic apparatus based on detection results obtained by the fingerprint sensor, the detection results including a detection result on a finger being in contact with the power button and a detection result on a finger being in contact with the operation button.

8. The electronic apparatus according to claim 1, wherein
the operation button is a second hardware button or a software button displayed on the electronic apparatus.

9. The electronic apparatus according to claim 1, wherein
the at least one processor cancels execution of the function when a finger is moved off the first hardware button during execution of the user authentication.

10. A non-transitory computer readable recording medium that stores a control program for controlling an electronic apparatus, which comprises a case, a hardware button located in one of a right side surface and a left side surface of the case, a fingerprint sensor configured to detect a fingerprint of a finger being in contact with the hardware button, and an operation button,
the control program causing the electronic apparatus to, when an operation is performed on the operation button in a state in which the hardware button is in contact with a finger, execute user authentication based on a fingerprint detection result obtained by the fingerprint sensor and execute the function assigned to the operation button.

11. An operating method of an electronic apparatus, which comprises a case, a hardware button located in one of a right side surface and a left side surface of the case, a fingerprint sensor configured to detect a fingerprint of a finger being in contact with the hardware button, and an operation button,
the operating method comprising executing user authentication based on a fingerprint detection result obtained by the fingerprint sensor and executing a function assigned to the operation button when an operation is performed on the operation button in a state in which the hardware button is in contact with a finger.
